(19) United States
(12) Patent Application Publication
(10) Pub. No.: US 2026/0093994 A1
(43) Pub. Date: Apr. 2, 2026

(54) ESTIMATION TECHNIQUES FOR EFFICIENT NEURAL NETWORK INFERENCE PROCESSING

(71) Applicant: Google LLC, Mountain View, CA (US)

(72) Inventors: Yashas Samaga, Mangalore (IN); Varun Yerram, Warangal (IN); Venkata Sesha Pavana Srinadh Bhojanapalli, New York, NY (US); Chong You, Jersey City, NJ (US); Sanjiv Kumar, Jericho, NY (US); Prateek Jain, Bangalore (IN); Praneeth Kumar Netrapalli, Bangalore (IN)

(21) Appl. No.: 19/054,567

(22) Filed: Feb. 14, 2025

(30) Foreign Application Priority Data
Oct. 1, 2024 (IN) 202411074274

(51) Int. Cl. G06N 3/0895; G06N 3/048

(52) U.S. Cl. CPC G06N 3/0895; G06N 3/048

(57) ABSTRACT

Methods, systems, and apparatus, including computer programs encoded on a computer storage medium, for estimation techniques for efficient neural network inference processing. In some implementations, parameter values for a trained neural network comprising multiple layers are stored, including (i) a matrix of parameter values for at least one layer and (ii) an approximate matrix of values corresponding to the at least one layer. Input is processed using the trained neural network, including determining an input for the at least one layer, computing approximate outputs corresponding to elements in a set using the approximate matrix, and computing intermediate outputs for only a proper subset of the elements in the set using the matrix of parameter values for the at least one layer. The proper subset is determined based on the approximate outputs.

### CROSS-REFERENCE TO RELATED APPLICATIONS

This application claims the benefit of priority to Indian Patent Application number 202411074274, filed in India on Oct. 1, 2024, the entire contents of which is incorporated herein by reference.

### STATEMENT REGARDING PRIOR DISCLOSURES BY THE INVENTOR OR A JOINT INVENTOR

Some of the subject matter in this application was previously disclosed by the inventors in a publication titled “HiRE: High Recall Approximate Top-k Estimation for Efficient LLM Inference,” arXiv:2402.09360v1, at https://arxiv.org/abs/2402.09360, Feb. 14, 2024, and the document is incorporated herein by reference.

### BACKGROUND

This specification relates processing sequences of data efficiently using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs, and/or in hardware or firmware, in one or more computers in one or more locations that can increase the speed and efficiency of processing by machine learning models. As a particular example, the system can perform highly accurate processing of neural networks, such as large language models (LLMs), in a highly computationally efficient manner.

When inference processing is performed for a neural network, much of the processing time is spent transferring model parameter values (e.g., weight values) or cached data (e.g., data in an attention cache) across various levels of a computer system's memory hierarchy (e.g., non-volatile storage, system memory (e.g., RAM), memory caches, etc.). In particular, even when high bandwidth memory (HBM) is available, much of the processing time is spent in transferring data from the HBM to accelerator chips or other processors (e.g., graphics processing units (GPUs), tensor processing units (TPUs), other devices performing matrix multiplication or other matrix operations). As a result, to reduce latency, it is desirable to limit the amount of data that is transferred from system memory, HBM, and other off-chip memory to the on-chip memory on an accelerator chip (e.g., processor chip). In many cases, processing is performed for each neural network layer for each input token to the neural network, and so the transfer of weight values or attention cache data is performed for each layer for each input token, which can result in significant delays, especially for neural networks with large layers or large context sizes.

The system described herein can reduce latency and reduce computational requirements of neural network layers. One technique is that the system can reduce the amount of processing performed, by using approximation techniques to identify a subset of weights or tokens that are most important or influential for a neural network layer, and then performing computation for a layer with the subset rather than the full set of weights or tokens. This allows the neural network to process layers using a fraction of the weights or tokens that would normally need to be transferred into memory and be processed, which reduces latency and computation. For example, the system can store for one or more layers an approximate matrix that can be used to select within a predetermined level of accuracy (e.g., as measured and targeted during training) a set of weights or tokens that includes the top-k most important or most influential fraction of weights or tokens, where k is an integer that is significantly less than the full set of weights or tokens that would otherwise be used. A first pass of approximate processing using the small approximate matrix is used to identify the subset of weights or tokens that are most important. Then, a second pass of processing (e.g., with full accuracy) is performed for just the identified subset, using non-approximate weights or tokens.

Because the approximate matrix is small and the subset of weights or tokens is much smaller than the full set of weights or tokens is small, both passes (e.g., selecting the most important subset, and processing that subset) can be performed with much lower latency and lower total computation than a single full pass that computes the layer in full. Just the same, the technique produces layer output results with high accuracy because the selection can be tuned to reliably select a subset that includes the top-k most important or most influential weights or tokens (even if other some less important weights or tokens are included also in the subset). The weights or tokens that are not in the subset (and so are omitted from processing in the second pass) are the ones that are least important or contribute less to the final result, and so do not significantly diminish the accuracy of the result. This enables the system to use a form of dynamically determined sparsity, where the set of weights that are ignored (e.g., not included in the subset for processing in the second pass) varies from one calculation to the next based on the content of the input to the layer and/or the context. Each time the layer is to be processed, the estimation and selection technique is used to select the weights or tokens that are most important or relevant for the layer based on the current input to the layer and/or current context. This way, a different subset of weights or tokens can be selected for each time the layer is processed, where each subset includes the top-k most important weights or tokens for that iteration of processing.

This technique reduces the transfer of model parameters for many layers, and reduce the transfer of attention cache data for attention layers, and in turn reduce the latency of processing overall. The system achieves these benefits without needing to allocate more extremely constrained on-chip memory to storing model weights or attention cache data. These techniques do not require a larger on-chip memory (e.g., memory on a processor or accelerator) and do not increase the allocation of the on-chip memory.

The system can reduce the amount of on-chip memory that is needed or that is utilized. As discussed further below, the system can perform a step of predicting the top-k weights or tokens, using approximate matrices that have a smaller data size or smaller in-memory storage size than the full matrices of the neural network. In some implementations, the approximate matrix for a layers of a neural network can be trained or tuned to predict the top-k elements for the corresponding layer to a predetermined level of accuracy, often during the training process of the neural network. Once trained, the approximate matrices for the layers can be stored, along with the full set of weights or parameters, for later use at inference time. The approximate matrices can be smaller due to, for example, storing parameter values for fewer parameters (e.g., using lower-rank approximate matrices) and/or quantizing parameter values to require fewer bits for each parameter value stored. As a result, loading an approximate matrix involves transferring less data into on-chip memory of an accelerator or other processor than transferring the original matrix. Once a subset of weights (that includes the top-k weights) is determined, the system can load only a portion of the weights from the original matrix for the layer. Rather than having to transfer the full matrix, the system can load only selected portions of the matrix (e.g., by loading and processing only the weights in the subset, or only specific groups of weights including those in the subset). Thus, the maximum or peak amount of on-chip memory needed to process a layer of the neural network can be reduced, since the approximate matrix and the selected portions of the full matrix used for any given processing cycle are lower than the data size of the full matrix.

The system achieves these benefits of lower latency data transfer to on-chip memory and lower usage of on-chip memory for attention layers also. For an attention layer, the system again uses one or more approximate matrices to predict a subset of elements that includes top-k elements. The approximate matrices are smaller than the corresponding original matrices, resulting in lower latency transfer and lower requirements and utilization of on-chip memory requirement compared to the full matrix. The elements can be representations of the input tokens, such as vectors generated by an embedding layer, or other context. Once the subset of these elements is determined, the full matrix for the attention layer can be used, but it can be used with only a fraction of the input representations or other context. For example, rather than apply the full matrix to the full set of vectors representing input tokens, the full matrix can be applied to only the vectors designated by the subset. This allows only the subset of vectors to be loaded and processed with the full matrix during the full-quality or full-precision attention processing.

In one general aspect, a method for performing efficient neural network processing uses selective processing of neural network parameters. The method is performed by one or more computers, and the method includes: storing, by the one or more computers, parameter values for a trained neural network comprising multiple layers, including storing for at least one layer of the multiple layers (i) a matrix of parameter values for the at least one layer and (ii) an approximate matrix of values corresponding to the at least one layer; processing, by the one or more computers, input using the trained neural network, including: determining an input for the at least one layer; computing approximate outputs corresponding to elements in a set using the approximate matrix corresponding to the at least one layer and the input for the at least one layer; computing intermediate outputs for only a proper subset of the elements in the set using the matrix of parameter values for the at least one layer, wherein the proper subset is determined based on the approximate outputs; and generating the output of the at least one layer based on the intermediate outputs; and providing, by the one or more computers, an output of the trained neural network that is generated based on the output of the at least one layer.

In some implementations, the at least one layer includes a softmax layer that has a softmax matrix and a corresponding approximate softmax matrix; computing the approximate outputs includes computing approximate softmax outputs for each element in a set using the approximate softmax matrix; computing the intermediate outputs includes computing softmax outputs for only the proper subset of the elements in the set using the softmax matrix, wherein the proper subset is determined based on the approximate softmax outputs; and generating the output of the at least one layer includes generating the output of the softmax layer based on the softmax outputs.

In some implementations, the at least one layer includes a feed-forward layer that has a feed-forward matrix and a corresponding approximate feed-forward matrix; computing the approximate outputs includes computing approximate feed-forward outputs for each element in a set using the approximate feed-forward matrix; computing the intermediate outputs includes computing feed-forward outputs for only the proper subset of the elements in the set using the feed-forward matrix, wherein the proper subset is determined based on the approximate feed-forward outputs; and generating the output of the at least one layer includes generating the output of the feed-forward layer based on the feed-forward outputs.

In some implementations, the at least one layer includes an attention layer that has one or more attention matrices and corresponding one or more approximate attention matrices; computing the approximate outputs includes computing approximate attention outputs for the sequence of vectors using the one or more approximate attention matrices; computing the intermediate outputs includes computing attention outputs for only a proper subset of the vectors in the sequence of vectors using the one or more attention matrices, and the proper subset is determined based on the approximate attention outputs; and generating the output of the at least one layer includes generating the output of the attention layer based on the attention outputs.

In some implementations, computing the approximate attention outputs includes computing approximate attention logits using the one or more approximate attention matrices; and computing the attention outputs includes using the attention matrices to compute attention logits restricted to the highest-ranking set of the approximate attention outputs.

In some implementations, processing the input using the trained neural network is performed by one or more accelerators having on-chip memory and associated off-chip memory; and the method includes, after computing the approximate attention outputs: based on the approximate attention outputs, selectively loading vectors from a sequence of vectors from the off-chip memory into the on-chip memory for processing with the one or more attention matrices.

In some implementations, the trained neural network is a large language model; and generating the output of the at least one layer includes generating output of the attention layer over a sequence of input token representations corresponding to a sequence of input tokens for the large language model.

In some implementations, the sequence of input token representations is a sequence of embeddings generated by an encoder of the trained neural network.

In some implementations, processing the input using the trained neural network is performed by one or more accelerators having on-chip memory and associated off-chip memory; and the method includes, after computing the approximate outputs: based on the approximate outputs, selectively loading a subset of weight values for the at least one layer from the off-chip memory into the on-chip memory for processing.

In some implementations, the approximate matrix for the at least one layer has been trained, separately from the training of the corresponding matrix for the at least one layer, with other layers of the trained neural network.

In some implementations, the approximate matrix for the at least one layer includes values for fewer parameters than the corresponding matrix for the at least one layer.

In some implementations, the approximate matrix for the at least one layer includes values stored using fewer bits per parameter than the corresponding matrix for the at least one layer.

In some implementations, the approximate matrix for the at least one layer is a low-rank approximation for the corresponding matrix for the at least one layer.

In some implementations, the approximate matrix for the at least one layer derived from the corresponding matrix through low rank decomposition of the corresponding matrix for the at least one layer.

In some implementations, the approximate matrix for the at least one layer includes quantized versions of parameter values of the corresponding matrix for the at least one layer.

In some implementations, the approximate matrix is factorized to include multiple matrices, wherein a total amount of parameter values in the multiple matrices is lower than an amount of parameter values in the corresponding matrix of the at least one layer.

In some implementations, the approximate matrix is configured to indicate, for different sets of input, different subsets of the elements that each include a highest-relevance subset of the elements.

In some implementations, the at least one layer has a set of hidden units, and wherein the set of hidden units is divided into groups that each comprise multiple hidden units. Generating the output of the at least one layer includes: determining an approximate group activation score for each of the groups, wherein each approximate group activation score is based on the approximate outputs for the hidden units in the group; computing intermediate outputs for only a proper subset of the groups of hidden units of the at least one layer using the matrix, wherein the proper subset of the groups is determined based on the approximate group activation scores; and generating the output of the at least one layer based on the intermediate outputs.

In another general aspect, a method performed by one or more computers includes: generating an output of a trained neural network, wherein generating the output of the trained neural network includes generating output of an attention layer of the trained neural network over a sequence of vectors using one or more attention matrices and one or more approximate attention matrices, wherein generating the output of the attention layer of the trained neural network includes: computing approximate attention outputs for the sequence of vectors using the one or more approximate attention matrices; computing attention outputs for only a proper subset of the vectors in the sequence of vectors using the one or more attention matrices, wherein the proper subset is based on a highest-ranking set of the approximate attention outputs; and generating the output of the attention layer based on the attention outputs.

In some implementations, generating the output of the trained neural network is performed by one or more accelerators having on-chip memory and associated off-chip memory.

In some implementations, the one or more accelerators comprise one or more graphics processing units or tensor processing units.

In some implementations, the method includes, after computing the approximate attention outputs: based on the approximate attention outputs, selectively loading vectors from the sequence of vectors from the off-chip memory into the on-chip memory for processing with the one or more attention matrices.

In some implementations, the method includes, after computing the approximate attention outputs, loading only vectors in the proper subset from the off-chip memory into the on-chip memory for processing with the one or more attention matrices.

In some implementations, computing the approximate attention outputs includes computing approximate attention logits using the one or more approximate attention matrices; and computing the attention outputs includes using the attention matrices to compute attention logits restricted to the highest-ranking set of the approximate attention outputs.

In some implementations, generating the output of the attention layer includes identifying a set of indices corresponding to a highest-ranking set of the approximate attention outputs; and the proper subset is based on the identified set of indices corresponding to the highest-ranking set of the approximate attention outputs.

In some implementations, generating the output of the attention layer includes selecting a highest-ranking set of the attention outputs as the output of the attention layer.

In some implementations, the method includes: storing the trained neural network comprising multiple neural network layers, wherein the trained neural network includes the attention layer having one or more attention matrices comprising parameter values learned through training of the trained neural network; and storing one or more approximate attention matrices, wherein each of the one or more approximate attention matrices corresponds to one of the one or more attention matrices, and wherein each approximate attention matrix of the one or more approximate attention matrices has a smaller data storage size than the corresponding attention matrix of the one or more attention matrices.

In some implementations, the trained neural network includes a multi-headed attention mechanism; the one or more attention matrices comprise at least one attention matrix for each of multiple attention heads; and the one or more approximate attention matrices comprise at least one approximate attention matrix for each of the multiple attention heads.

In some implementations, the trained neural network has a transformer architecture comprising one or more feedforward network layers, a softmax layer, and the attention layer; the one or more attention matrices comprise multiple attention matrices for each of multiple attention heads, wherein the one or more attention matrices comprise, for each of the multiple attention heads, (i) a query matrix having values learned through training of the trained neural network and (ii) a key matrix having values learned through training of the trained neural network; and the one or more approximate attention matrices comprise multiple approximate attention matrices for each of multiple attention heads, wherein the one or more approximate attention matrices comprise, for each of the multiple attention heads, (i) an approximate query matrix having values and (ii) an approximate key matrix.

In some implementations, the trained neural network is a large language model; and the sequence of vectors is a sequence of input token representations corresponding to a sequence of input tokens for the large language model.

In some implementations, the sequence of vectors is a sequence of embeddings generated by an encoder of the trained neural network, wherein the embeddings are generated by the encoder as representations of input tokens in a sequence of input tokens.

In some implementations, the output of the trained neural network is an output that identifies an output token.

In some implementations, the trained neural network is configured to process a series of vectors in a context window; and the method includes performing multiple processing steps that each correspond to a different vector, wherein each processing step is based on a different sequence of vectors in the context window, including, for each processing step: using the one or more approximate attention matrices to compute approximate attention outputs for the current processing step based on the sequence of vectors that are in the context window for the current processing step; using the one or more attention matrices to compute attention outputs for the current processing step for only a proper subset of the vectors in the sequence of vectors, wherein the proper subset is based on a highest-ranking set of the approximate attention outputs for the current processing step; and generating the output of the attention layer for the current processing step based on the attention outputs for the current processing step.

In some implementations, each approximate attention matrix of the one or more approximate attention matrices has a smaller data storage size than the corresponding attention matrix of the one or more attention matrices

In some implementations, each approximate attention matrix of the one or more approximate attention matrices includes values for fewer parameters than the corresponding attention matrix of the one or more attention matrices.

In some implementations, each approximate attention matrix of the one or more approximate attention matrices includes values stored using fewer bits per parameter than the corresponding attention matrix of the one or more attention matrices.

In some implementations, each approximate attention matrix of the one or more approximate attention matrices is a low-rank approximation for the corresponding attention matrix of the one or more attention matrices.

In some implementations, each approximate attention matrix of the one or more approximate attention matrices is factorized to include multiple matrices, wherein a total amount of parameter values in the multiple matrices is lower than an amount of parameter values in the corresponding attention matrix of the one or more attention matrices.

In some implementations, each approximate attention matrix of the one or more approximate attention matrices has been trained, separately from the training of the corresponding attention matrix, with other layers of the trained neural network.

In some implementations, each approximate attention matrix of the one or more approximate attention matrices has been derived from the corresponding attention matrix through low rank decomposition.

In some implementations, each approximate attention matrix of the one or more approximate attention matrices includes quantized versions of parameter values of the corresponding attention matrix of the one or more attention matrices.

In some implementations, each approximate attention matrix of the one or more approximate attention matrices includes parameter values that are stored using one half or one quarter of a number of bits of the parameter values of the corresponding attention matrix of the one or more attention matrices.

In some implementations, the parameter values of the one or more attention matrices are floating point values, and wherein each of the parameter values is stored using a first number of bits; and the one or more approximate attention matrices comprise quantized parameter values, and wherein each of the quantized parameter values is an integer value stored using a second number of bits that is lower than the first number of bits.

In some implementations, generating the output of the attention layer includes: identifying a set of indices corresponding to a first predetermined number of highest-ranking approximate attention outputs from the approximate attention outputs computed using the one or more approximate attention matrices; identifying a second predetermined number of highest-ranking attention outputs from among the attention outputs computed using the one or more attention matrices, wherein the attention outputs are computed only for vectors corresponding to the identified set of indices; and wherein the second predetermined number is less than the first predetermined number.

In some implementations, generating the output of the attention layer based on the attention outputs includes generating the output of the attention layer from the identified second predetermined number of highest-ranking attention outputs.

In some implementations, generating the output of the attention layer based on the attention outputs includes deriving the output of the attention layer using only the identified second predetermined number of highest-ranking attention outputs.

In some implementations, the second predetermined number is one half or less, one fifth or less, one tenth or less, or one twentieth or less than the first predetermined number.

In some implementations, the first predetermined number is one half or less, one fifth or less, one tenth or less, or one twentieth or less than the number of vectors in the sequence of vectors for which approximate attention outputs are computer using the one or more approximate attention matrices.

In some implementations, the first predetermined number, the second predetermined number, and parameter values of the one or more approximate attention matrices are configured such that, without computing a full set of attention outputs including an attention output for each of the vectors in the sequence of vectors determined using the one or more attention matrices: the identified set of indices corresponding to the first predetermined number of highest-ranking approximate attention outputs, which are taken from the approximate attention outputs computed using the one or more approximate attention matrices, is a superset of a second set of indices corresponding to the second predetermined number of highest-ranking attention outputs selected from among the full set of attention outputs that includes an attention output computed for each of the vectors in the sequence of vectors using the one or more attention matrices.

In some implementations, the first predetermined number, the second predetermined number, and parameter values of the one or more approximate attention matrices are configured such that if the one or more attention matrices were used to compute a full set of attention outputs comprising an attention output for each of the vectors in the sequence of vectors, then each of the indices in a second predetermined number of highest-ranking attention outputs form the full set of attention outputs would be included in the identified set of indices corresponding to the first predetermined number of highest-ranking approximate attention outputs.

In some implementations, the identified second predetermined number of highest-ranking attention outputs, determined from among attention outputs for only vectors in the highest-ranking set of the approximate attention outputs, is a same set of highest-ranking attention outputs that would be obtained by (i) computing an attention output for each of the vectors in the sequence of vectors using the one or more attention matrices and (ii) identifying the second predetermined number of highest-ranking attention outputs from among the set of attention outputs computed for each of the vectors in the sequence of vectors using the one or more attention matrices.

In some implementations, the trained neural network has a transformer architecture, and the sequence of vectors is a sequence of embeddings generated by an embedding layer of the trained neural network as representations of input tokens for the trained neural network.

In some implementations, the trained neural network includes: an embedding layer configured to produce an embedding as a representation for input tokens for the trained neural network; a sequence of alternating attention layers and feed forward layers configured to receive and process the embedding from the embedding layers; and a softmax layer configured to produce a set of output values.

In some implementations, the trained neural network includes a softmax layer that has a corresponding softmax matrix; and wherein generating the output of the trained neural network includes generating output of the softmax layer, including: computing approximate softmax outputs for each element in a set using one or more approximate softmax matrices; computing softmax outputs for only a proper subset of the elements in the set using the softmax matrix, wherein the proper subset is determined based on a highest-ranking set of the approximate softmax outputs; and generating the output of the softmax layer based on the softmax outputs.

In some implementations, the elements in the set are nodes of the softmax layer, and wherein the proper subset is the subset of the nodes of the softmax layer that correspond to the highest-ranking set of the approximate softmax outputs.

In some implementations, generating the output of the trained neural network is performed by one or more accelerators having on-chip memory and associated off-chip memory; the method further includes after computing the approximate softmax outputs: based on the approximate softmax outputs, selectively loading parameter values from the softmax matrix from the off-chip memory into the on-chip memory for processing to compute the softmax outputs used to generate the output of the softmax layer.

In some implementations, the method includes, after computing the approximate softmax outputs, loading, from the parameter values of the softmax matrix stored in the off-chip memory, only parameter values designated by the proper subset into the on-chip memory for processing to compute the softmax outputs used to generate the output of the softmax layer.

In some implementations, the softmax matrix includes weight values for nodes of the softmax layer, and only the weight values corresponding to the proper subset are transferred to the on-chip memory to compute the softmax outputs used to generate the output of the softmax layer.

In some implementations, the trained neural network includes a feed-forward layer that has a corresponding feed-forward matrix; and wherein generating the output of the trained neural network includes generating output of the feed-forward layer, including: computing approximate feed-forward outputs for each element in a set using one or more approximate feed-forward matrices; computing feed-forward outputs for only a proper subset of the elements in the set using the feed-forward matrix, wherein the proper subset is determined based on a highest-ranking set of the approximate feed-forward outputs; and generating the output of the feed-forward layer based on the feed-forward outputs.

In some implementations, the elements in the set are nodes of the feed-forward layer, and wherein the proper subset is the subset of the nodes of the feed-forward layer that correspond to the highest-ranking set of the approximate feed-forward outputs.

In some implementations, the feed-forward layer has a set of hidden units, and wherein the set of hidden units is divided into groups that each comprise multiple hidden units; and wherein generating the output of the feed-forward layer includes: determining an approximate group activation score for each of the groups, wherein each approximate group activation score is based on the approximate feed-forward outputs for the hidden units in the group; computing feed-forward outputs for only a proper subset of the groups of hidden units of the feed-forward layer using the feed-forward matrix, wherein the proper subset of the groups is determined based on a highest-ranking set of the approximate group activation scores; and generating the output of the feed-forward layer based on the feed-forward outputs.

In some implementations, generating the output of the trained neural network is performed by one or more accelerators having on-chip memory and associated off-chip memory; and the method further includes after computing the approximate feed-forward outputs: based on the approximate feed-forward outputs, selectively loading parameter values from the feed-forward matrix from the off-chip memory into the on-chip memory for processing to compute the feed-forward outputs used to generate the output of the feed-forward layer.

In some implementations, method includes, after computing the approximate feed-forward outputs, loading, from the parameter values of the feed-forward matrix stored in the off-chip memory, only parameter values designated by the proper subset into the on-chip memory for processing to compute the feed-forward outputs used to generate the output of the feed-forward layer.

In some implementations, the feed-forward matrix includes weight values for nodes of the feed-forward layer, and only the weight values corresponding to the proper subset are transferred to the on-chip memory to compute the feed-forward outputs used to generate the output of the feed-forward layer.

In some implementations, the highest-ranking set from a group of values is determined based on magnitudes of the values in the group.

In another general aspect, a method performed by one or more computers include: generating an output of a trained neural network, wherein the neural network comprises a particular layer having a corresponding layer matrix that includes parameter values for the particular layer, wherein generating the output of the trained neural network comprises generating output of the particular layer, wherein generating the output of the particular layer includes: computing approximate layer outputs for the particular layer using one or more approximate layer matrices, wherein the approximate layer matrices have a smaller data size than the layer matrix that includes the parameter values of the particular layer; computing layer outputs using only a proper subset of the parameter values in the layer matrix, wherein the proper subset is based on a highest-ranking set of the approximate layer outputs; and generating the output of the particular layer based on the layer outputs.

In some implementations, the particular layer is a feed-forward layer or a softmax layer.

In some implementations, the parameter values are weight values for nodes of the particular layer.

In some implementations, the one or more approximate layer matrices comprise a matrix having quantized parameter values from the layer matrix.

In some implementations, the one or more approximate layer matrices comprise a low-rank factorization of the layer matrix.

In some implementations, wherein generating the output of the trained neural network is performed by one or more accelerators having on-chip memory and associated off-chip memory; and wherein computing the layer outputs using only a proper subset of the parameter values in the layer matrix comprises, for a current processing step used to generate the output of the neural network at the current processing step (or for the current input token or output token), transferring from off-chip memory only the only the parameter values from the layer matrix that are included in the proper subset.

Other embodiments of these and other aspects described herein include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

Details of one or more implementations are set forth in the accompanying drawings and the description below. Other features, objects, and advantages will be apparent from the description and drawings, and from the claims.

### DESCRIPTION OF DRAWINGS

FIG. 1 is a diagram depicting an example system for providing efficient processing for neural networks.

FIG. 2A is a diagram that illustrates an example of performing efficient processing for an attention layer.

FIG. 2B is a diagram that illustrates an example of performing efficient processing for a feed-forward layer.

FIG. 2C is a diagram is a diagram that illustrates an example of performing efficient processing for a softmax layer.

FIG. 3 is a diagram showing an example of processing for high-recall approximate top-k estimation.

FIG. 4 is a graph showing an example of results showing reduced latency in processing a neural network, with results for several different context sizes.

FIG. 5 is a graph showing efficiency of memory transfer for different group sizes.

FIG. 6 is a graph showing an example of results of top-k activations for different layers.

Like reference symbols in the various drawings indicate like elements.

### DETAILED DESCRIPTION

In some implementations, a computer system is configured to perform efficient processing for neural networks, using estimation techniques to reduce the amount of data transferred and reduce the amount of computation required. As discussed below, the system can use high-recall approximate top-k estimation to enhance processing for a neural network layer. To achieve higher efficiency and lower latency, the system can efficiently identify the top-k fraction of weights or tokens for a layer.

In previous approaches, exploiting sparsity for improving latency has been hindered because identifying top rows, columns, or tokens is data-dependent (e.g., changes from one processing cycle to the next based on input) and is usually performed using full matrix operations. Using full matrix operations across the entire set of rows, columns, or tokens to identify the top-k fraction is itself a processing-intensive task that can also involve data transfer latency, which has previously limited the degree that sparsity could improve latency. However, the current system overcomes many of these limitations by more quickly and more efficiently identifying the top-k fraction of weights or attention cache data for a layer. This can involve (i) compression of matrix data (e.g., network parameter values) with approximations and the use of the approximate matrix to predict a subset that includes the top-k rows, columns, or tokens with high recall (e.g., completeness or high accuracy in including the top-k items), and (ii) restricting full computation performed using the non-approximated matrix to the predicted subset. This way, the processing is more efficient through the use of the smaller approximation to efficiently and accurately select a subset of items to be processed, and high accuracy is maintained using the original, non-approximated matrix data to process the items in the subset.

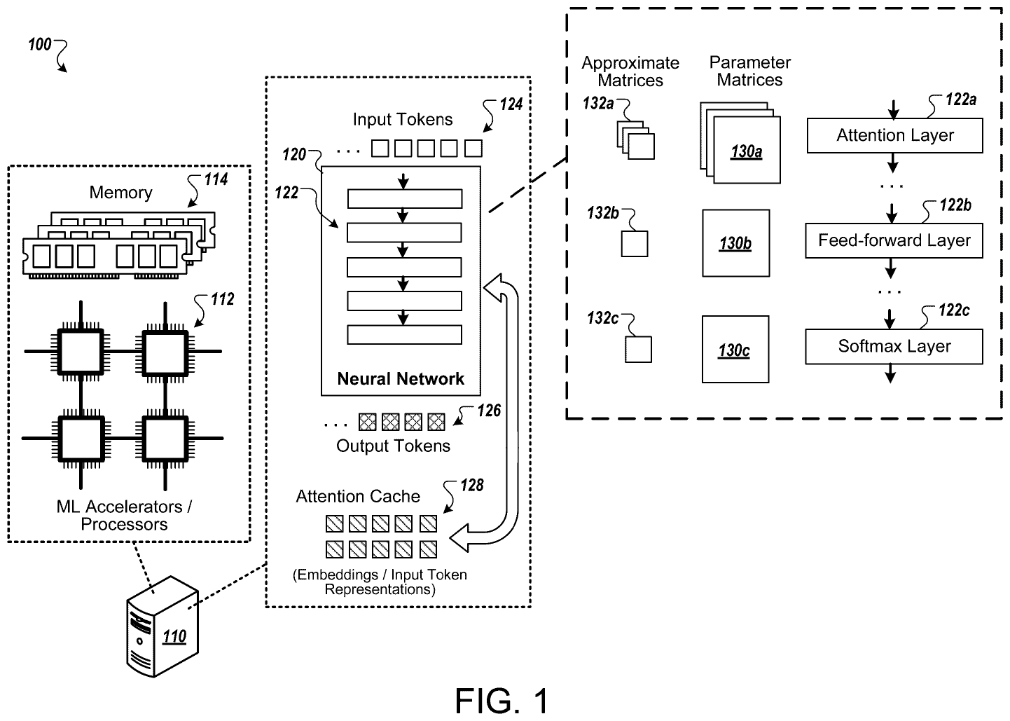

FIG. 1 is a diagram depicting an example system 100 for providing efficient processing for neural networks. The system 100 include a computer system 110, which can be one or more servers, a data center, a workstation, a desktop computer, a laptop computer, a tablet computer, a smart phone, etc. The computer system 110 includes one or more machine learning accelerators or processors 112 (referred to simply as “accelerators 112”), such as tensor processing units (TPUs), graphics processing units (GPUs), central processing units (CPUs), etc. The computer system 110 also includes memory 114, such as high-bandwidth memory (HBM), random-access memory (RAM), etc. The computer system 110 also includes non-volatile data storage to store the neural network 120 and other data.

In the example, the computer system 110 stores a neural network 120 and is configured to efficiently perform inference operations for the neural network 120. The neural network 120 has already been trained, and the computer system 110 stores the parameter values for neural network 120 (e.g., weight values for neurons). The neural network 120 includes multiple layers 122, which can be of various different types. The neural network 120 can include one or more transformers or includes features of the transformer architecture. The techniques described herein can be used for neural networks of many different types. In some implementations, the neural network 120 is a large language model. In some implementations, the neural network is configured to process text data, image data, video data, audio data, or other data. The neural network 120 can be a multimodal neural network that is configured to process input and/or provide output for two or more different type of media or types of data.

When performing processing using the neural network 120, the computer system 110 determines a set of input tokens 124, which can represent text or other input to the neural network 120. The input tokens 124 are typically processed in sequence, using multiple iterations of processing using the layers 122. Often, input tokens are processed with an encoder (e.g., one or more encoder layers) that produce embeddings as input token representations. The embeddings can be stored in an attention cache 128 where the embeddings can be used in further iterations of processing. In the neural network 120, each neural network layer 122 receives an input, typically from one or more preceding layers, and produces output, typically provided to one or more subsequent layers. Processing proceeds through the neural network for each of the input tokens 124 sequentially, and the neural network 120 produces a sequence of output tokens as the output of the process.

When performing processing for the neural network 120, a significant amount of the processing time is often taken by waiting for data transfer, such as the transfer of parameter values (e.g., weight values) and data (e.g., elements from the attention cache 128) that are needed for the computations. Each of the accelerators 112 typically has associated memory with high bandwidth, often local memory that is on-chip or on-package (e.g., cache memory). This local memory has a limited size, however, and so parameter values for the layers 122 and the contents of the attention cache 128 frequently need to be transferred from memory 114 to the local memory or cache memory of the accelerators 122 before the processing can occur, which incurs latency.

The computer system 110 can reduce the latency involved in performing the processing by limiting the amount of data transfer require, for parameter values of the layers 122 and for contents of the attention cache 128. The computer system 110 can achieve this by using estimation techniques to predict a subset of items to be used in processing for a layer 122, and then performing the full processing using only the subset. The subset that is predicted or selected can be determine in a way that it reliably includes the top-k fraction of items that are most important or influential to achieving an accurate result. When the estimation is done appropriately, the combined amount of data transfer combined for the estimation (e.g., subset determination) and the full processing of the subset is less than would be needed to fully process the layer, which can result in significant reduction in latency.

The example of FIG. 1 shows additional detail for three different types of layers 122, an attention layer 122a, a feed-forward layer 122b, and a softmax layer 122c. Each of these layers has a parameter matrix 130 that includes parameter values (e.g., weight values) that were learned through the training process for the parameters in the layer. Each of the layers 122 can also have an approximate matrix 132 that is a smaller, approximated version. The approximate matrix 132 for a layer 122 may be smaller in any of various different ways, e.g., fewer values, quantized values, compressed values, trained as a smaller model, includes values representing groups of parameters (e.g., multiple values across columns or rows), etc. In the example, each attention head can have multiple parameter matrices 130a, e.g., a query weight matrix and a key weight matrix, as well as corresponding approximate matrices 132a, e.g., an approximate query weight matrix and an approximate key weight matrix. There can be multiple attention heads for each attention layer 122a, with parameter matrices 130a and corresponding approximate matrices 132a for each. There is a parameter matrix 130b that includes the weights of the feed-forward layer 122b and an approximate matrix 132b for the feed-forward layer 122b. There is also a parameter matrix 130c that includes the weights of the softmax layer 122c and an approximate matrix 132c for the softmax layer 122c. In some implementations, the approximate matrices 132 are derived from the corresponding parameter matrices 130. In some implementations, the approximate matrices 132 are separately trained from the parameter matrices 130, during the training process for the neural network 120.

To predict a subset of items that includes a top-k fraction, the computer system 110 can use the approximate matrices 132 that are approximations for the full matrices 130 of the neural network 120. The approximate matrices 132 can be smaller so that data transfer time is reduced and in some cases processing requirements can be reduced also. The approximate matrices 132 can be applied across the full set of parameters (e.g., weights) or tokens to generate approximate outputs, which are then ranked or otherwise evaluated to identify a highest-ranking fraction. Although the goal is to select the top-k elements, the size of the highest-ranking fraction that is selected can be larger than k, so that the subset or highest-ranking fraction selected using the approximate matrices 132 is a superset of the top-k fraction (e.g., includes the top-k items and others). Making the subset larger than k can provide a margin to account for potential inaccuracies resulting from use of estimation based on the approximate matrices 132. In some cases, the approximate matrices 132 and the size of subsets selected using the approximate matrices 132 can be set to guarantee that the top-k items will be included, at least within a predetermined likelihood or margin.

When performing processing for a layer 122, after a subset is determined using one or more approximate matrices 132 corresponding to that layer 122, the original, non-approximated parameter matrix 130 (e.g., as determined during training of the neural network) is used to perform calculations for the items in the subset. Thus, rather than transfer the entire parameter matrix 130 and perform the full set of calculations with the original parameter matrix 130, only a subset of the layer's calculations is performed and only a fraction of the data is transferred. For feed-forward layers 122b and softmax layers 122c, the subset can be a subset of the weight values of the corresponding parameter matrix 130b, 130c, so that output of the layer can be calculated using only the weight values that are most significant or influential for the current input to the layer. For attention layers 122a, the subset that is selected can be a subset of the tokens or vectors that the attention layer would process. For example, the subset can indicate coordinates or indices of a subset of items in the attention cache 128, e.g., in a context window or in a sequence of vectors representing input tokens and/or prior output tokens.

In the case that the approximate matrices 132 are trained (e.g., rather than derived from the values of the parameter matrices 130), the approximate matrices 132 can be trained with a different set of constraints or objectives than the corresponding parameter matrices 130. For example, rather than being trained to produce output that will propagate through the neural network 120 to create an accurate output, the approximate matrices 132 can be trained with an objective to approximate the corresponding parameter matrices 130, in order to reliably indicate which of the parameters in the corresponding layer 122 are most important or significant (e.g., will have the strongest activation) for a given set of input to the layer. One example training process for training the approximate matrices 132a is performed after training of the parameter matrices 130a is complete. The approximate matrices 132a (e.g., approximate query weight matrix and approximate key weight matrix) are then trained minimize cross-entropy loss between (1) approximate attention probabilities determined using the approximate matrices 132a and (2) attention probabilities determined using corresponding parameter matrices 130a.

When used for inference processing, the outputs calculated using the approximate matrices 132 are not passed on as output of the layer 122 to be further processed by other layers 122 in the neural network. Instead, the outputs calculated using the approximate matrices 132 are used only to select the subset of weights or tokens that will then be processed in full using the corresponding parameter matrices 130. As a result, the activations or results of processing using an approximate matrix 132 can simply indicate a set that includes the top-k elements for the layer 122 given the current input to the layer 122. To do this, the approximate matrix 132 generally should produce results that is correlated with or aligns with result from the parameter matrix 130 for the same layer, but as long as the top-k selection is accurate, any other inaccuracy in the approximate matrix 132 will not affect the output of the neural network 120.

In general, deploying large language models (LLMs) is very expensive due to the cost of running inference on accelerators 112, and has significant environmental costs. For example, some estimates attribute 80-90% of the total carbon emissions during the life cycle of an LLM to inference.

Latency and cost of generative LLMs is dominated by the autoregressive next-token generation, which is memory-bound on standard accelerators (GPU/TPUs) due to shuttling of large matrices from high-bandwidth memory (HBM) to the accelerator cache memory. Generative LLM inference is still primarily memory-bound, which leaves significant room for latency and cost reduction. Further, depending on the model size and sequence length, different components within the transformer such as attention layers, feedforward layers, and softmax layers might dominate the total latency. Improving the efficiency and reducing latency for any of these types of layers is beneficial, and techniques with broad applicability across all of these three types of layers are especially beneficial to addressing high inference cost/latency of LLMs.

LLMs often exhibit inherent sparsity, which tends to grow with larger models. For instance, feedforward (FFN) layers activations, particularly those with ReLU based activation functions, can be very sparse. Similarly, the usual attention mechanism, where each token attends to all other tokens (bi-directional attention) or all the tokens appearing before it (causal attention), can be replaced with top-k attention, where each token attends only to the top-k tokens with the highest attention probabilities, without impacting quality of the model. Finally, softmax layers usually need to focus only on the very small set of relevant tokens corresponding to the largest logits. This provides the opportunity for the present system to compute the top elements of softmax output, FFN activations, and attention logits efficiently and accurately on accelerators.

In many cases, the top-k elements are input dependent, and so the top-k elements vary from one processing iteration to the next as the input and context varies. The challenge is to estimate top-k elements without fully evaluating the softmax layers, FFN layers, and attention layers. In addition, after estimating the top elements' coordinates, efficiently gathering those elements (e.g., transferring the data of those elements from memory to the processor(s)) is a challenge on modern accelerators such as TPUs. This document describes techniques that can overcome these challenges and can substantially improve the inference latency of autoregressive LLMs without compromising quality.

An example of the approximation techniques that can be used to improve efficiency is High Recall Approximate Top-k Estimation (HIRE) of the top-k elements. HiRE uses low rank projection or aggressive quantization or a combination of both for efficiently estimating the top-k outputs of softmax layers, FFN layers, and attention layers, followed by exact computation on the predicted set. One important aspect of the techniques is high-recall estimation, such as identifying a set of elements S which is guaranteed to contain all the top-k elements, even though S might contain many more elements than k. Another aspect is efficient training procedures. For example, the quantization-based approach does not require any further training, while the low-rank-based approach is designed to minimize further training costs (e.g., 0.1% compute relative to the training cost of the original model in our experiments). The system can include hardware-aware changes made based on important inference time settings such as distributed top-k approximations to make it more efficient when deployed on multiple devices. Another significant aspect is extending HIRE to perform efficient top-k attention while prior work considered only FFN or softmax layers, or used fewer heads in attention layers.

HIRE-Softmax: In the softmax layer 122c, systems typically are interested only in the top few (k≤32) outputs from a very large output space with hundreds of thousands of tokens. On a model with about one billion parameters, the implementation of HiRE gives a significant end-to-end latency improvement without any loss in quality.

HIRE-FFN: While LLMs trained with a top-k operation have relatively sparse activations, k≥5% is usually required for a feed-forward layer 122b to ensure that there is no loss in accuracy (in contrast to the softmax layer 122c, where the effective sparsity is ≤0.3%). Now, the amount of time taken to gather the relevant top-k columns of the weight matrix from main memory turns out to be substantially more than that required to bring an equivalently sized dense matrix. To overcome this hardware limitation, a group sparse top-k operation can be used, where columns of the weight matrix are grouped into groups of small sizes (8 in our experiments) which significantly improves the efficiency of memory transfers. HiRE-FFN gives a significant end-to-end latency improvement, without any quality drop. A combination of HIRE-Softmax and HiRE-FFN give an even larger end-to-end latency improvement compared to the fully dense model.

HiRE-Attention (HiRE-Attn): This technique for the attention layer 122a uses a low rank approximation and aggressive quantization to cheaply compute approximate attention logits, and then compute the exact logits restricted to the top-k set from the approximate logits. On a model trained for sequences with a length of a few thousand tokens, the approximation retains high quality on both pretraining and downstream tasks. The technique can speed up attention layers significant, such as by more 2× for longer context lengths such as 16384 or higher.

In some systems, a sparse softmax has been used as computationally cheap screening model to quickly identify a subset of labels to reduce inference latency of classification with large vocabulary sizes. The screening models were developed using singular value decomposition (SVD), clustering of embedding vectors, clustering of final representations, etc. However, these approaches were developed in the context of extreme multilabel classification. An advantage of HiRE-Softmax is a more efficient post-training procedure for aggressive quantization and a very efficient end-to-end training procedure to learn a lower dimensional projection that works on LLMs.

In some systems, a sparse FFN has been used, where large language models have highly sparse activation patterns with ReLU based activation functions. There have been several recent attempts to exploit activation sparsity for faster inference, but they suffer some loss in quality since the activation pattern cannot be predicted exactly. In contrast, the technique of the present system of estimating activation sparsity with high recall can ensure matching quality (e.g., no loss in quality), since exact computation can be performed on all of the activations that are estimated to be non-zero, and even if some of them later turn out to be zero, it doesn't affect the actual output. This document introduces several new ideas such as group sparsity with very small group sizes, using a common dense path, exploiting activation overlap across tokens, and distributed gathering of weights, which are very effective at improving efficiency without loss in accuracy and in extending this approach to larger batch sizes, larger number of samples and larger models with model partitioning.

While replacing full quadratic attention with top-k attention retains quality, there is not always a way of exploiting this for faster inference. The primary reason is that there need to be efficient ways to identify the top-k tokens as well as be able to gather the relevant pieces of key-value cache efficiently. Previous work has attempted to overcome these issues through structured sparsity. However, all structured sparsity approaches result in loss in quality, while unstructured top-k attention does not. The present system shows how to make top-k attention efficient and retain high quality.

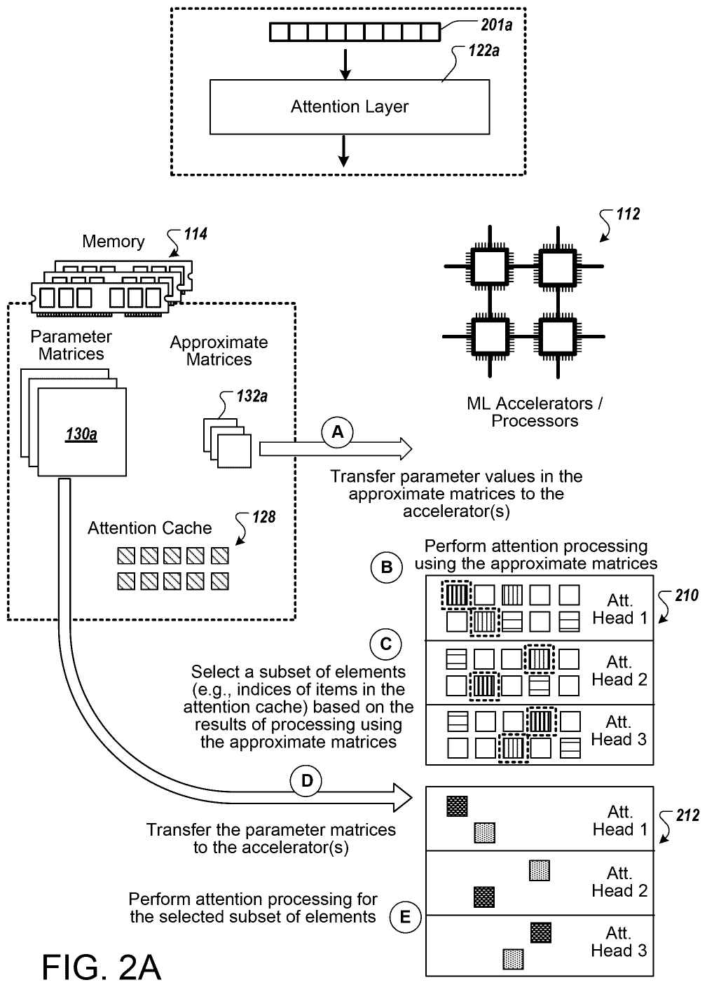

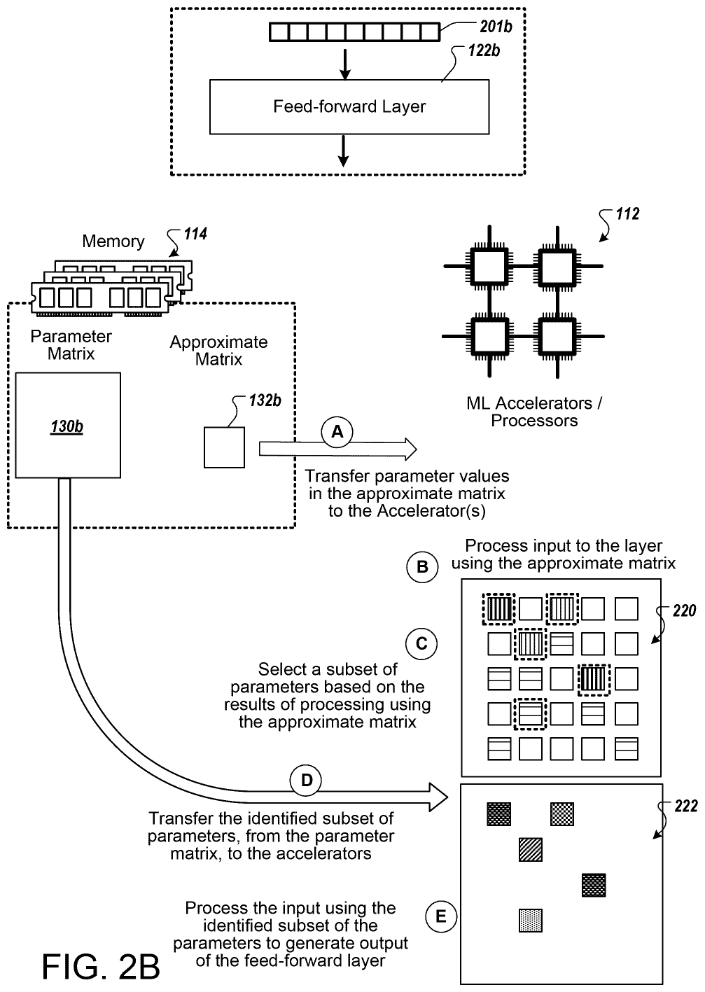

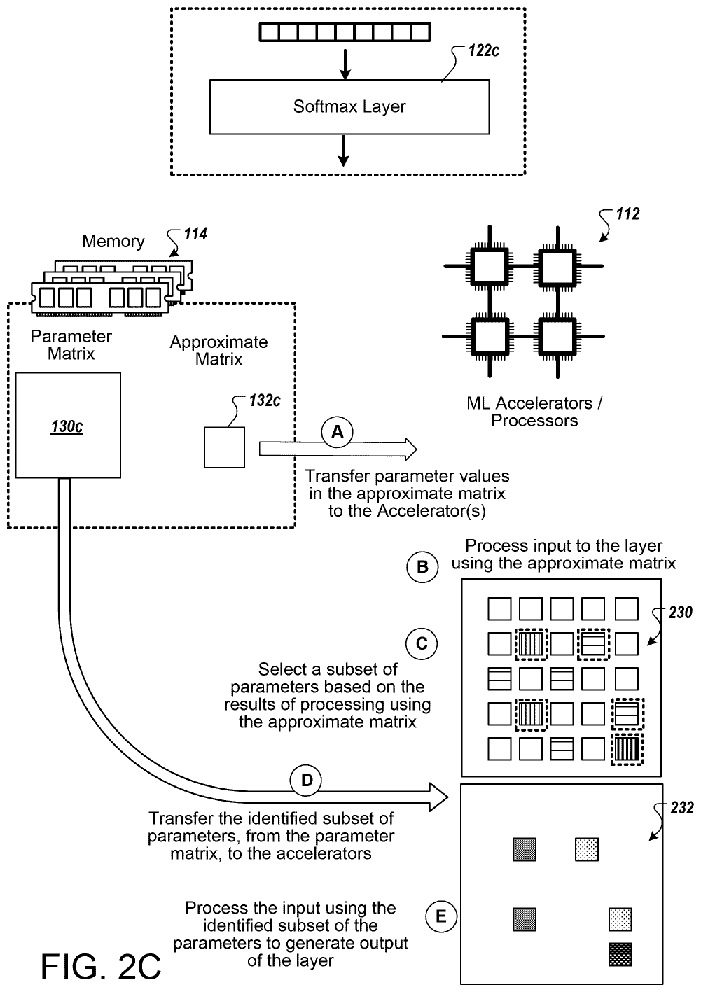

FIG. 2A is a diagram that illustrates an example of performing efficient processing for an attention layer 122a. The example represents processing performed for a single attention layer 122a of the neural network 120, for a pass through the network 120 in which the attention layer 122a receives input represented by input vector 201a. In the example, the approximate matrices 132a are used to efficiently compute approximate attention logits. A subset is selected based on the approximate attention logits, and then the parameter matrices 130a are used to compute the actual full logits for only the subset. The example shows processing that occurs in a series of stages labeled (A) to (E).

In the example, processing is shown for three attention heads, but more or fewer attention heads can be used. In addition, although only three parameter matrices 130a and three approximate matrices 132a are illustrated, each attention head can have its own set of matrices (e.g., a key weight matrix and a query weight matrix, as well as an approximate key weight matrix and an approximate query weight matrix.

In stage (A), the approximate parameter values in the approximate matrices 132a are transferred to the accelerators 112. In stage (B), the accelerators 112 perform attention processing using the approximate matrices 132a. This can include computing a set of approximate attention logits 210 for each of multiple attention heads. The attention can be computed for each element in the current content, e.g., for each element in the attention cache 128. For example, an attention score can be determined for each of the elements in the attention cache 128. The attention computations can be performed with low computational cost by using low rank approximations and aggressive quantization for the approximate matrices 132a. Based on the training used to generate the values for the approximate matrices 132a, or the way the approximate matrices 132a were otherwise derived, selecting a predetermined amount or fraction (set to be larger than k) of the approximate attention logits reliably includes the top-k elements for the parameter matrices 130a (e.g., the top-k most important or relevant logits).

In stage (C), the computer system 110 selects a subset of elements based on the approximate attention logits 210. For example, the strongest activations or highest values can be identified as the most important or influential for the calculation for the current layer 122a, given the current input 201a and contents of the attention cache 128. In the illustrated example, each attention head generates ten different approximate attention scores, corresponding to the ten items in the attention cache 128. The shading indicates the score, with darker shading indicating a higher attention score. The computer system 110 selects the top two attention scores for each attention head, which are marked with dotted lines to show their selection. On later iterations of processing, when different input 210a is provided and there is different contents of the attention cache 128, different elements would be selected as most relevant.

In stage (D), the computer system 110 transfers the parameter matrices 130a to the accelerators 112 for the next pass of processing for the layer 122a, which will be used to determine the output of the layer 122a. In stage (E), the computer system 112 uses the accelerators 112 to perform attention processing for the selected subset of items, e.g., the elements from the attention cache corresponding to the selected approximate attention logits or selected highest attention scores. The processing generates attention logits 212 for only the indices or items in the subset. In this way, the full-precision, full-accuracy computation of attention is performed only for the subset of elements selected in stage (C). Limiting the computation required in this way can significantly reduce latency and processing time for the attention layer 122a, especially as the size of the context increases. The attention logits 212 then serve as an intermediate output or output of the layer 122a to other layers 122 in the neural network 120.

FIG. 2B is a diagram that illustrates an example of performing efficient processing for a feed-forward layer 122b. The example represents processing performed for a single feed-forward layer 122b of the neural network 120, for a pass through the network 120 in which the feedforward layer 122b receives input represented by input vector 201b. In the example, the approximate matrix 132a is used to efficiently compute a set of approximate activations or outputs. A subset is selected based on the approximate outputs, and then the parameter matrix 130a are used to compute the actual full outputs for only the parameters represented by the subset. The example shows processing that occurs in a series of stages labeled (A) to (E).

In stage (A), the approximate parameter values in the approximate matrix 132b are transferred to the accelerators 112. The approximate matrix 132b is much smaller than the parameter matrix 130b, and so can be transferred much faster. The approximate matrix 132 can use lower precision for the values compared to the parameter matrix 130b. In some implementations, the approximate matrix 132 can include fewer values, with each value in the approximate matrix 132b representing a group of multiple parameter values in the parameter matrix 130b, so fewer values overall need to be transferred.

In stage (B), the accelerators 112 process the input 201b to the layer 122b using the approximate matrix 132b. This can include computing a set of approximate outputs 220 or activations. The computations can be performed with lower computational cost compared to the parameter matrix 130b due to the smaller size, lower precision, or smaller number of values in the approximate matrix 132b. Based on the training used to generate the values for the approximate matrix 132b, or the way the approximate matrix 132b were otherwise derived, selecting a predetermined amount or fraction (set to be larger than k) of the approximate outputs 220 reliably includes the top-k elements that would be indicated most important or influential by processing the same input 201b using the parameter matrix 130b.

In stage (C), the computer system 110 selects a subset of parameters of the layer 122b based on the approximate outputs 220. For example, the strongest activations (whether positive or negative) or highest absolute value of the outputs 220 can be identified as the most important or influential for the calculation for the current layer 122b given the input 201b. In the illustrated example, the level of shading is indicative of strength of activation, with darker shading indicating a higher influence. The computer system 110 selects the top five outputs 220, which are marked with dotted lines to show their selection. The amount of items to be selected (e.g., the number of outputs 220 or parameters to select) can be consistent for the layer each time, selected to be large enough to consistently include the top-k elements. The selection here indicates that the model parameters corresponding to these selected outputs are most important for the processing of this layer 122b given the input 201b. On later iterations of processing, when different input 201b is provided, different parameters would be selected as most relevant.

In stage (D), the computer system 110 selectively transfers parameter values from the parameter matrix 130b to the accelerators 112 for the next pass of processing for the layer 122b, which will be used to determine the output of the layer 122b. Instead of transferring the entire parameter matrix 130b, only the parameters corresponding to the selected subset are transferred. This is not required to be one-to-one, however, since in some cases one of the approximate outputs 220 may represent a group of multiple parameters from the parameter matrix 130b.

In stage (E), the computer system 112 uses the accelerators 112 to perform processing for the selected subset of parameter values, e.g., only for the weight values from the parameter matrix 130b that correspond to the selected parameters determined from the approximate outputs 220. In this way, the full-precision, full-accuracy computation of attention is performed only for the subset of parameters selected in stage (C). Limiting the computation required in this way can significantly reduce latency and processing time for the feed-forward layer 122b. The processing generates feed-forward outputs 222 as an intermediate output or as output of the feed-forward layer 122b to the next layer 122 in the neural network 120.

FIG. 2C is a diagram is a diagram that illustrates an example of performing efficient processing for a softmax layer. The example represents processing performed for a single softmax layer 122c of the neural network 120, for a pass through the network 120 in which the feedforward layer 122c receives input represented by input vector 201c. In the example, the approximate matrix 132a is used to efficiently compute a set of approximate activations or outputs. A subset is selected based on the approximate outputs, and then the parameter matrix 130a are used to compute the actual full outputs for only the parameters represented by the subset. The example shows processing that occurs in a series of stages labeled (A) to (E).

In stage (A), the approximate parameter values in the approximate matrix 132c are transferred to the accelerators 112. The approximate matrix 132c is much smaller than the parameter matrix 130c, and so can be transferred much faster. The approximate matrix 132 can use lower precision for the values compared to the parameter matrix 130c. In some implementations, the approximate matrix 132 can include fewer values, with each value in the approximate matrix 132c representing a group of multiple parameter values in the parameter matrix 130c, so fewer values overall need to be transferred.

In stage (B), the accelerators 112 process the input 201c to the layer 122c using the approximate matrix 132c. This can include computing a set of approximate outputs 230 or activations. The computations can be performed with lower computational cost compared to the parameter matrix 130c due to the smaller size, lower precision, or smaller number of values in the approximate matrix 132c. Based on the training used to generate the values for the approximate matrix 132c, or the way the approximate matrix 132c were otherwise derived, selecting a predetermined amount or fraction (set to be larger than k) of the approximate outputs 230 reliably includes the top-k elements that would be indicated most important or influential by processing the same input 201c using the parameter matrix 130c.

In stage (C), the computer system 110 selects a subset of parameters of the layer 122c based on the approximate outputs 230. For example, the strongest activations (whether positive or negative) or highest absolute value of the outputs 230 can be identified as the most important or influential for the calculation for the current layer 122c given the input 201c. In the illustrated example, the level of shading is indicative of strength of activation, with darker shading indicating a higher influence. The computer system 110 selects the top five outputs 230, which are marked with dotted lines to show their selection. The amount of items to be selected (e.g., the number of outputs 230 or parameters to select) can be consistent for the layer each time, selected to be large enough to consistently include the top-k elements. The selection here indicates that the model parameters corresponding to these selected outputs are most important for the processing of this layer 122c given the input 201c. On later iterations of processing, when different input 201c is provided, different parameters would be selected as most relevant.

In stage (D), the computer system 110 selectively transfers parameter values from the parameter matrix 130c to the accelerators 112 for the next pass of processing for the layer 122c, which will be used to determine the output of the layer 122c. Instead of transferring the entire parameter matrix 130c, only the parameters corresponding to the selected subset are transferred. This is not required to be one-to-one, however, since in some cases one of the approximate outputs 230 may represent a group of multiple parameters from the parameter matrix 130c.

In stage (E), the computer system 112 uses the accelerators 112 to perform processing for the selected subset of parameter values, e.g., only for the weight values from the parameter matrix 130c that correspond to the selected parameters determined from the approximate outputs 230. In this way, the full-precision, full-accuracy computation of attention is performed only for the subset of parameters selected in stage (C). Limiting the computation required in this way can significantly reduce latency and processing time for the softmax layer 122c. The processing generates softmax outputs 232 as an output of the softmax layer 122c, which may be an output to another layer 122 in the neural network 120 or may be an output of the neural network 120 as a whole.

In the examples of FIGS. 2A-2C, different types of layers may have different numbers of items in their respective subsets that are selected based on the approximate outputs. Similarly, the principle of selecting a subset that will include the top-k elements is in common for all layer types, the value of k may be different for different layers or layer types. In the neural network 120, one or more layers 122 may take advantage of the efficiency provided by the top-k estimation and selection, but not all layers 122 need to use the technique. The neural network 120 may include multiple layers of the attention, feed-forward, and/or softmax types, and each instance of a layer may have the parameters for subset size, value of k to be guaranteed in the subset, and so on set separately, tuned for the characteristics of that layer (e.g., size, function, etc.).

In further detail, a transformer begins with an embedding layer which produces the representation for the input tokens, then processes them through a sequence of alternating attention and feed forward layers, and finally ends with a softmax layer that produces the output probabilities. The current focus is the softmax, feed forward (FFN) and attention layers, which are now described.

The softmax layer takes an input \vec{x}∈ [symbol] ^{d} and outputs:

$$Softmax ( \vec{x} ) := \frac{exp ( W \vec{x} )}{{‖ exp ( W \vec{x} ) ‖}_{1}} ∈ {ℝ}^{c} , \qquad ( 1 )$$

where W∈ [symbol] ^{d×c}, d is called the model dimension and c is the number of output classes. In almost all of the applications, we only care about accurately estimating the conditional distribution on the top-k output probabilities for some k i.e.,

$$Softmax ( \vec{x} ) := \frac{{Top}_{k} ( Softmax ( \vec{x} ) )}{{‖ {Top}_{k} ( Softmax ( \vec{x} ) ) ‖}_{1}} ∈ {ℝ}^{c} , \qquad ( 2 )$$

where Topₖ(⋅) operation takes a vector as input, retains the values of the top-k entries and sets the remaining to zero. In particular, we only care about estimating the location and values of the top-k entries of Softmax (\vec{x}).

The feed-forward (FFN) layer takes an input \vec{x}∈ [symbol] ^{d} and outputs:

$$FF ( \vec{x} ) := {\sum }_{j = 1}^{m} ϕ ( 〈 {\vec{u}}_{j} , \vec{x} 〉 ) {\vec{v}}_{j} , \qquad ( 3 )$$

where φ(⋅) is an activation function, m is the number of hidden units and \vec{u}ⱼ∈ [symbol] ^{d} and \vec{v}ⱼ∈ [symbol] ^{d} are the first and second layer weights respectively. We refer to (Eqn. 3) as the standard or dense FFN layer. It turns out that for specific activation functions like (powers of) ReLU, for any given x, the number of j for which the activations φ( [symbol] \vec{u}ⱼ, \vec{x} [symbol] ) is non-zero in a trained LLM is small (≤10%). If we explicitly do a top-k step in the feedforward evaluation, i.e.,

$${FF}_{k} ( \vec{x} ) := {\sum }_{j ∈ S ( \vec{x} )} ϕ ( 〈 {\vec{u}}_{j} , \vec{x} 〉 ) {\vec{v}}_{j} , \qquad ( 4 )$$

where S(\vec{x}):=TopIndₖ(φ(U^{T}\vec{x})), where U is the matrix whose j^{th} column is \vec{u}ⱼ and TopIndₖ(\vec{z}) denotes the set of indices where the top-k entries occur in \vec{z}, then the number of non-zeros reduces even further without drop in quality for k≈5%. We refer to (Eqn. 4) as the sparse or top-k FFN layer.

The (causal) attention layer with H heads and query, key, value and projection matrices Qₕ, Kₕ, Vₕ∈ [symbol] ^{d}^{ₖ}^{×d}^{ₘ} and Pₕ∈ [symbol] ^{d}^{ₘ}^{×d}^{ₕ}, for the h^{th} head respectively, where dₘ is the representation dimension/model dimension, and dₕ is the dimension per head, takes a set of input token representations \vec{x}ᵢ∈ [symbol] ^{d}, i=1, . . . n, where n is the total number of tokens, and for each i∈[n], outputs

$$Attn ( {\vec{x}}_{i} ) = {\sum }_{h = 1}^{H} {P}_{h} {\sum }_{j ∈ {S}_{h} ( {\vec{x}}_{i} )} {\tilde{p}}_{ijh} {V}_{h} \cdot {\vec{x}}_{i} , \qquad ( 5 )$$

where the attention probabilities p_{igh} are given by

$${p}_{ijh} := exp ( {( {Q}_{h} {\vec{x}}_{i} )}^{T} ( {K}_{h} {x}_{j} ) ) / {\sum }_{r = 1}^{i} exp ( {( {Q}_{h} {\vec{x}}_{i} )}^{T} ( {K}_{h} {x}_{r} ) ) .$$

sparsified version of the attention layer given by

$${Attn}_{k} ( {\vec{x}}_{i} ) := {\sum }_{h = 1}^{H} {P}_{h} {\sum }_{j ∈ {S}_{h} ( {\vec{x}}_{i} )} {\tilde{p}}_{i j h} {V}_{h} \cdot {\vec{x}}_{i} . \qquad ( 5 )$$

where Sₕ(\vec{x}ᵢ)=TopIndₖ(pᵢⱼₕ: j∈[i]=TopIndₖ((Qₕ\vec{x}ᵢ)^{T} (Kₕxⱼ): j∈[i]) and \tilde{p}ᵢⱼₕ:=exp((Qₕ\vec{x}ᵢ)^{T} (Kₕxⱼ)/Σ_{r∈s}_{ₕ}(exp((Qₕ\vec{x}ᵢ)^{\grave{T}} (Kₕxᵣ)) for every J∈Sₕ(\vec{x}ᵢ), retains the quality of the full attention model Attn (\vec{x}ᵢ).

We now abstract out the key component that can speed up top-k based softmax (Eqn. 2), FFN (Eqn. 4) and attention layers (Eqn. 5) as follows. Given a matrix Z∈ [symbol] and a vector \vec{x}∈ [symbol] ^{d}, we wish to compute:

$$S = \{ ( i , ϕ ( 〈 {\vec{z}}_{i} , \vec{x} 〉 ) ) : i ∈ {TopInd}_{k} ( ϕ ( {Z}^{⊤} \vec{x} ) ) \} , \qquad ( 6 )$$

where \vec{z}ᵢ is the i^{th} column of Z and φ(⋅) is any given activation function (could be identity for softmax (Eqn. 2)), and d<< [symbol] . Our goal is to design an efficient mechanism to compute S in (Eqn. 6) compared to the baseline approach of computing φ(Z^{T}\vec{x}) followed by a top-k operation.

Theoretical proxy for quantifying efficiency: Autoregressive decoding for small batch sizes is memory bound, i.e., the time taken for transferring model parameters across different hierarchies of memory (e.g., HBM/RAM to cache) of the accelerator device (GPU/TPU) is the largest component of the total inference latency. To quantify this intuition, and get a sense of how much we are improving inference latency, only in the current section, we use the number of effective parameters (measured in terms of bytes taken to store them) used by a given algorithm A for the computation in (Eqn. 6) as a proxy for its latency, and refer to it as PS (A). For example, the Baseline which first computes φ(Z^{T}\vec{x}) followed by a top-k operation has PS (Baseline)=2d [symbol] since Z is a d× [symbol] matrix, which is stored in 16-bit floating point (bf16) format.

We now present the key ideas behind HIRE, and its application to softmax, FFN and attention layers. First, techniques are presented for solving (eqn. 6) accurately and efficiently.

The key idea behind HIRE is that given an approximate, and smaller version of the matrix Z, denoted by Zₐₚₚᵣₒₓ, we first approximate φ(Z^{T}\vec{x}) with φ(Zₐₚₚᵣₒₓ^{T}\vec{x}), use it to compute the set of top-k′ elements S′ for some k′>k, compute

$$ϕ ( Z {\vert}_{{S}^{′}}^{⊤} \vec{x} )$$

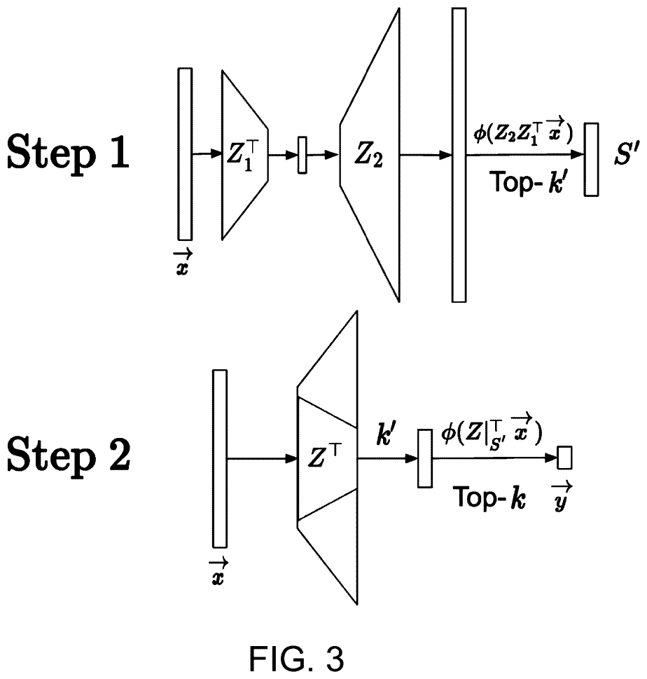

for only indices restricted to S′, and then perform the top-k operation on the resulting vector. A pseudocode of HIRE is presented in Algorithm 1 and a schematic diagram is presented in FIG. 3. As long as TopIndₖ(φ(Z^{T}\vec{x}))⊆S′, we have that

$${Top}_{k} ( ϕ ( {Z}^{⊤} \vec{x} ) ) = {Top}_{k} ( ϕ ( Z {\vert}_{{S}^{′}}^{⊤} \vec{x} ) ) .$$

If the size of Zₐₚₚᵣₒₓ is chosen to be substantially smaller than that of Z, and if k′<< [symbol] , then HIRE executes much faster than the naive version of implementing (Eqn. 6). In this paper, we consider two ways of choosing Zₐₚₚᵣₒₓ.

Algorithm 1 Pseudocode for HiRE

input \vec{x}, Z, Zₐₚₚᵣₒₓ, k, k′
1: S′ + TopInd_{k′} (φ(Zₐₚₚᵣₒₓ^{T} \vec{x})) {Top-k′ indices of φ {Zₐₚₚᵣₒₓ^{T} \vec{x})}
$2 : \vec{y} ← {Top}_{k} ( Z \vert \begin{matrix}T \\ {S}^{′}\end{matrix} \vec{x} )$
output \vec{y}

Algorithm 2 Pseudocode for HiRE with DA-TOP-k

input \vec{x}, Z, Zₐₚₚᵣₒₓ, k. k′ with Z and Zₐₚₚᵣₒₓ distributed across s machines.
$1 : On machine i ∈ [ s ] : {S}_{i}^{′} ← {TopInd}_{\frac{{k}^{′}}{s}} ( ϕ ( {{Z}_{{approx}_{j}}}^{T} \vec{x} ) ) \{ Top - \frac{{k}^{′}}{s} indices of ϕ ( {{Z}_{{approx}_{i}}}^{T} \vec{x} ) \} on$
machine i.}
$2 : {\vec{y}}_{i} ← {Top}_{\frac{k}{s}} ( Z \vert \begin{matrix}T \\ {S}^{′}\end{matrix} \vec{x} )$
3: y ← Concat(yᵢ : i ∈ [s]).
output \vec{y}

FIG. 3 shows a schematic of the HiRE technique. To compute the top-k elements of φ(Z^{T}\vec{x}), we first compute an approximate top-k′ set S′ by using a low rank approximation

$${Z}_{approx} = {Z}_{1} {Z}_{2}^{⊤} .$$

The then compute

$$ϕ ( Z {\vert}_{{S}^{′}}^{⊤} \vec{x} )$$

for Z restricted to S′ and then perform top-k operation on that vector.

HIRE-LR: In this case, we choose Zₐₚₚᵣₒₓ to be a low rank matrix factorized as

$${Z}_{1} * {Z}_{2}^{⊤} where {Z}_{1} ∈ {ℝ}^{d \times r} and {Z}_{2} ∈ {ℝ}^{ℓ \times r}$$

for some r<<d. In this case PS (HIRE-LR)=2(dr+r [symbol] +dk′), which will be much smaller than 2d [symbol] since r<<d<< [symbol] and k′<< [symbol] . Note that this requires us to train Zₐₚₚᵣₒₓ either in an end to end manner, or by performing low rank decomposition on Z. However, there is a high potential for latency gains here since r could potentially be chosen to be very small.

HiRE-Q: In this case, we choose Zₐₚₚᵣₒₓ to be a aggressively quantized version of Z for example in 4-bit integer format (int4). In this case,

$$PS ( HiRE - Q ) = \frac{d ℓ}{2} + 2 {dk}^{′} ,$$

which will be much smaller than 2d [symbol] since k′<< [symbol] . Note that this does not require any training since we can just apply a standard quantization routine to Z to obtain Zₐₚₚᵣₒₓ. However, the potential gains are limited due to inherent limits on quantization. Note that we can also combine both HIRE-LR and HiRE-Q to obtain further inference latency improvements. We will now present the application of Algorithms 1 and 2 to make softmax, FFN and attention layers more efficient.

HIRE-SOFTMAX: efficient softmax processing using HIRE. Since we usually care only about the top-k logits of the softmax layer (Eqn. 4), we can directly apply Algorithms 1 and 2 to solve (Eqn. 2) more efficiently. We note that while obtaining Wₐₚₚᵣₒₓ, an approximate version of W, is straightforward with quantization, obtaining a low rank approximation of Wₐₚₚᵣₒₓ is also relatively cheap since we can distill the inputs and outputs of W to obtain Wₐₚₚᵣₒₓ.

Table 1 below shown results of evaluation of HIRE-Softmax with the baseline dense model Mbase on a single TPUv5e device. For HIRE-Softmax, we use three different kinds of approximation: HIRE-LR with low rank approximation, HiRE-Q with int4 quantization and then finally HIRE-LRQ with both low rank and int4 quantization. We notice similar speedups with both HIRE-Q and HiRE-LR as both of them reduce the size of parameters that are used for computation to 25%.

TABLE 1

| | | | [symbol] ₛₘ | | |
|---|---|---|---|---|---|
| | | | | | HiRE-LR |
| | | | HiRE-LR | HiRE-Q | r = 25%, |
| | | | (r = 25%, | (int4, | k′ = 384) + |
| | | [symbol] _{base} | k′ = 384) | k′ = 128) | HiRE-Q (int4) |
| Pre-training | Top1 Accuracy | 57.15% | 57.07% | 57.12% | 57.07% |
| Performance | Top32 Intersection | 32.0 | 29.26 | 31.48 | 29.03 |
| Downstream | Machine Translation | 47.92 | 47.73 | 47.9 | 47.77 |
| Performance | SuperGLUE Benchmark | 62.0 | 61.39 | 61.56 | 61.02 |
| | Question Answering | 29.65 | 29.58 | 29.54 | 29.58 |
| | Discriminative Tasks | 51.69 | 30.31 | 50.92 | 50.40 |

| | | | | |
|---|---|---|---|---|
| Speedup | 3.0× | 3.16× | 1.16× | 1.22× |

HIRE-FFN: efficient feed-forward network processing using HIRE. Recalling (Eqn. 4), we note that we can compute S(\vec{x}): =TopIndₖ(φ(U^{T}\vec{x})) using HIRE. While HiRE-FFN is indeed theoretically more efficient compared to a naive computation of (Eqn. 4), it turns out that for the relative values of k′ and m that are needed to ensure that there is no accuracy drop (k′m≈0.05), the transfer of parameters across different hierarchies of memory in a very unstructured fashion is too inefficient to give any gains on modern throughput-optimized acclerators1. Our insight is that group sparse structure substantially improves the efficiency of parameter transfer across different hierarchies of memory. For example, the efficiency of the transfer operation of columns of a matrix across different hierarchies of memory improves substantially when we transfer groups of adjacent columns instead of single columns. More concretely, we first divide the entire set of m hidden units into m/g groups with g hidden units each (in all our experiments, we use g=8). Given an approximate group activation computation procedure

$$Φ : {ℝ}^{d} \to {ℝ}^{\frac{m}{g}} , i . e . , Φ ( \vec{x} ) \approx ( {\sum }_{k = 0}^{g - 1} \vert ϕ ( 〈 {\vec{u}}_{g * j + ℓ} , \vec{x} 〉 ) \vert : j ∈ [ m / g ] )$$

lest us denote

$${S}_{g}^{′} := {TopInd}_{{k}^{′}} ( Φ ( \vec{x} ) ) ,$$

and use:

$${g \cdot \frac{{k}^{′}}{g}}_{} ( \vec{x} ) := {\sum }_{j ∈ {S}_{g}} {\sum }_{ℓ = 0}^{g} ϕ ( 〈 {\vec{u}}_{g * j + ℓ} , \vec{x} 〉 ) {\vec{v}}_{g * j + ℓ} ,$$

where \tilde{S}_{g}⊆[m/g] is a subset of groups selected as

$${\tilde{S}}_{g} := {GroupTopInd}_{g , k / g} ( ϕ ( U \vert \begin{matrix}⊤ \\ {{S}^{′}}_{g}\end{matrix} \vec{x} ) ) ,$$

where S′_{g} is an estimate of the groups of neurons that will actually be activated. We can again use Algorithm 1 (resp. Algorithm 2) to compute \tilde{S}_{g} in the single (resp. multiple) device settings.

HIRE-ATTN: efficient attention layer processing using HIRE. Recalling (Eqn. 5), we note that we wish to compute Sₕ(\vec{x}ᵢ):=TopIndₖ((Qₕ\vec{x}ᵢ)^{T} (Kₕ\vec{x}ⱼ): j∈(\vec{x}ᵢ) efficiently. Denote \vec{q}ₕᵢ:=Qₕ\vec{x}ᵢ and \vec{k}ₕᵢ:=Kₕ\vec{x}ᵢ. For HIRE-Q, we aggressively quantize \vec{q}ₕᵢ and \vec{k}ₕᵢ to int4 to compute \tilde{p}ᵢⱼₕ. For HIRE-LR, we learn new \tilde{Q}ₕ and \tilde{K}ₕ∈ [symbol] ^{\tilde{d}}^{ₕ}^{×d}^{ₘ} where \tilde{d}ₕ<<dₕ, and let \tilde{\vec{q}}ₕᵢ:=\tilde{Q}ₕ\vec{x}ᵢ, and \tilde{\vec{k}}ₕᵢ:=\tilde{K}ₕ\vec{x}ᵢ. We then compute approximate probabilities

$${\tilde{p}}_{ijh} := exp ( {\vec{q}}_{hi}^{⊤} {\vec{k}}_{hj} ) / {\sum }_{r = 1}^{i} exp ( {\vec{q}}_{hi}^{⊤} {\vec{k}}_{hr} ) ,$$

and approximate Sₕ(\vec{x}ᵢ) with high recall using \tilde{S}ₕ(\vec{x}ᵢ)==TopInd_{k′}(\tilde{p}ᵢⱼₕ: j∈[i]) for some k′>>k. Given a pretrained model, we freeze its parameters and train \tilde{Q}ₕ and \tilde{K}ₕ by minimizing cross entropy loss CE (\tilde{p}_{i·h}, p_{i·h}) between \tilde{p}ᵢⱼₕ and pᵢⱼₕ (for different i and h).

Table 2 below shows an example of results from evaluation of HiRE-FFN, as well as a combination of HiRE-Softmax+HiRE-FFN with the baseline dense modelMbase on a single TPUv5e device. For HIRE-FFN, we use quantization based HIRE, while for HIRE-Softmax, we use HIRE-LRQ. Note that the combination of HIRE-Softmax+HiRE-FFN is 1.47× faster than baseline despite almost matching accuracy.

TABLE 2

| | | | | [symbol] _{ffn} (HiRE Q) + |
|---|---|---|---|---|
| | | | [symbol] _{ffn} | [symbol] ₛₘ (HiRE-Q + |
| | | Baseline | (HiRE-Q) | HiRE-LR) |
| Pre-training | Top1 Accuracy | 57.15% | 57.03% | 56.93% |
| Performance | Perplexity | 2.045 | 2.056 | NA |
| Downstream | Machine Translation | 47.92 | 46.95 | 46.94 |
| Performance | SuperGLUE Benchmark | 62.0 | 62.49 | 61.74 |
| | Question Answering | 29.65 | 30.88 | 30.86 |
| | Discriminative Tasks | 51.69 | 51.14 | 50.08 |

| | | | |
|---|---|---|---|
| Speedup | 1.0× | 1.16× | 1.47× |

Next, we present experimental evaluation of HIRE and demonstrate its efficacy in reducing inference latency. All experiments were conducted on a model with about 1 billion parameters—we denote it by 1B model. dₘ denotes its model dimensions, i.e., dimension of representations.

HIRE-FFN: After pretraining 1B for a large number of steps (M), we continue to pretrain it for a similar number of additional steps with group sparse top-k operation on odd FFN layers to obtain M_{ffn}, i.e., if the model has [symbol] layers, then we modify only the 1st, 3rd, . . . , (2*└ [symbol] /2┘−1)^{th} layers to be group sparse. For fair comparison we continue to pretrain M for the same number of additional steps as M_{ffn}, but without the top-k operation to obtain the baseline model M_{base}. While the exact computations are all performed in bf16 (a 16 bit floating point format), the approximate computations in HIRE are performed after casting the int4 parameters to bf16 just before use (i.e., the parameters were transferred form memory in int4 but they are casted to bf16 just before using them).

HIRE-Softmax: We apply HIRE-Softmax to Mbase or Mffn with different choices for approximate computation. For approximate computation with low rank, we train Wapprox using cross entropy (CE) loss with respect to ground truth labels, with rank r chosen to be r=dₘ/4. For approximate computation with quantization, we perform the softmax computation in int4.

We also present results combining both low rank and quantization approximation. We refer to the model with HiRE on both Softmax and FFN layers as M_{full}, while HiRE-Softmax applied to M_{base} is referred to as Mₛₘ.

HiRE-Attn: We apply HiRE-Attn to M_{base} with both low rank and quantization approaches for the approximate computation. For quantization, we perform int4 quantization of queries (\vec{q}ₕᵢ) and keys (\vec{k}ₕⱼ), without modifying any model parameters, for computing approximate attention probabilities \tilde{p}ᵢⱼₕ. For low rank, we choose \tilde{d}ₕ=dₕ/2 and k′=64 and train lower dimensional query and key matrices, \tilde{Q}ₕ and \tilde{K}ₕ respectively using cross entropy loss as described above. The resulting model is referred to as Mₐₜₜₙ. We evaluate the performance of different models both in terms of quality as well as inference latency. We measure quality using evaluation on pre-training dataset as well evaluations on multiple downstream datasets. Following standard works in the domain, we compute downstream performance of the model by applying it to multiple tasks, each focusing on a specific capability of LLMs.

Table 3 below shows results of an evaluation of HiRE-Attn with the baseline dense model M_{base} with context length of 2048 on a single TPUv5e device. For HIRE-Attn, we use three different kinds of approximation: HiRE-LR with low rank approximation, HiRE-Q with int4 quantization and then finally HIRE-LRQ with both low rank and int4 quantization.

TABLE 3

| | | | [symbol] ₐₜₜₙ | | |
|---|---|---|---|---|---|
| | | | | | HiRE-LR |
| | | | HiRE-LR | HiRE-Q | (r = 50%, |
| | | | (r = 50%, | (int4, | k′ = 64) + |
| | | [symbol] _{base} | k′ = 64) | k′ = 64) | HiRE-Q (int4) |
| Pre-training | Top1 Accuracy | 57.15% | 56.9% | 57.04% | 56.91% |
| Performance | | | | | |
| Downstream | Machine Translation | 47.92 | 47.75 | 47.84 | 47.61 |
| Performance | SuperGLUE Benchmark | 62.0 | 61.43 | 61.82 | 61.23 |
| | Question Answering | 29.65 | 29.74 | 29.63 | 28.72 |
| | Discriminative Tasks | 51.69 | 51.42 | 51.39 | 51.25 |

We evaluate the performance of different models both in terms of quality as well as inference latency. We measure quality using evaluation on pre-training dataset as well evaluations on multiple downstream datasets. Following standard works in the domain, we compute downstream performance of the model by applying it to multiple tasks, each focusing on a specific capability of LLMs. Collectively these datasets provide us a thorough assessment framework. To facilitate evaluation of our pretrained base models we perform 1-shot evaluations on all datasets. Types of tasks tested include Machine Translation, SuperGLUE Benchmark, Question Answering, and Discriminative Tasks.

For Question Answering evaluations we use Exact Match as our metric (Except F1-score for TyDiQA), Accuracy for Discriminative tasks and Character n-gram F-score for machine translation. For each task group, we report the Macro-Average of task metrics in our downstream evaluations.

For evaluating inference latency, we use a single TPUv5e device with batch size of one. For HIRESoftmax and HiRE-FFN, we report end-to-end speedup by measuring number of response tokens generated per unit time step. For HIRE-Attn, we report speedup obtained for a toy attention-only model consisting of equal number of attention layers as in M_{base} since the relative contribution of the attention layer to the overall latency is quite small for small sequence lengths (e.g., <8192).

HIRE-Softmax: Table 1 presents a comparison of Mₛₘ (i.e., HiRE applied to the softmax layer of M_{base}) with the baseline dense model (M_{base}). Note that both HiRE-Q and HiRE-LR provide about 1.16× speedup over baseline while providing almost the same next-token prediction accuracy on the pretraining dataset. Downstream accuracy is also within 0.2% of the baseline. We observe that combining HIRE-Q and HIRE-LR improves the latency speedup to 1.22× with less than 0.5% overall drop in accuracy.

HIRE-FFN: Table 2 presents a comparison of both HiRE-FFN (M_{ffn}) as well as the full HIRE approach applied to both the Softmax and FFN layers (M_{full}), with respect to the original model (M_{base}). Similar to softmax layer, here again combining HiRE-LR and HiRE-Q leads to as much as 1.47× latency reduction while maintaining almost similar pre-training and downstream evaluation accuracy.

HIRE-Attn: Table 3 presents a comparison of the baseline model M_{base} with HiRE-Attn model Mₐₜₜₙ in terms of pretraining and downstream evaluations. The results demonstrate that HIRE-LR, HIRE-Q as well as HIRE-LRQ retain the quality of the original model. FIG. 2 shows the speedup attained by HiRE-Attn compared to the standard attention layers as we scale to larger context lengths. We see that for context length of 16384, HiRE-Attn speeds up attention layer by a factor of over 2×.

HiRE-Softmax: Table 1 above presents a comparison of Mₛₘ (i.e., HiRE applied to the softmax layer of M_{base}) with the baseline dense model (M_{base}). Note that both HiRE-Q and HiRE-LR provide about 1.16× speedup over baseline while providing almost the same next-token prediction accuracy on the pretraining dataset. Downstream accuracy is also within 0.2% of the baseline. We observe that combining HiRE-Q and HIRE-LR improves the latency speedup to 1.22× with less than 0.5% overall drop in accuracy.

HIRE-FFN: Table 2 above presents a comparison of both HiRE-FFN (M_{ffn}) as well as the full HiRE approach applied to both the Softmax and FFN layers (M_{full}), with respect to the original model (M_{base}). Similar to softmax layer, here again combining HIRE-LR and HiRE-Q leads to as much as 1.47× latency reduction while maintaining almost similar pre-training and downstream evaluation accuracy.

HiRE-Attn: Table 3 above presents a comparison of the baseline model M_{base} with HiRE-Attn model Mₐₜₜₙ in terms of pretraining and downstream evaluations. The results demonstrate that HIRE-LR, HIRE-Q as well as HIRE-LRQ retain the quality of the original model. FIG. 2 shows the speedup attained by HiRE-Attn compared to the standard attention layers as we scale to larger context lengths. We see that for context length of 16384, HiRE-Attn speeds up attention layer by a factor of over 2×.

Importance of high recall estimation: Consider Algorithm 1 and (Eqn. 6). We define Recall as the intersection between the set of elements, S′ computed using Zₐₚₚᵣₒₓ matrix and S using Z matrix. In the case of Softmax, we compute the intersection between S′ and S for both HIRE-LR and HiRE-Q in Table 4. We see a systematic increase of recall with increase in k′ of the algorithm. In case of M_{ffn}, we evaluate models with different (k′, k) pairs to study the importance of high recall in pretraining metrics. In other experiments, we observed that, using a larger k′ compared to k is important to retain the accuracy of the original model, further signifying the importance of high recall.

Table 4 below shows the importance of High Recall for HIRE-Softmax. This table presents the pretraining top-1 accuracy as well as the size of intersection with the top-k tokens of the original model, when we use different values of k′ in the approximate computation step and k=32. k′=None refers to the setting where we do not follow the approximate computation by an exact computation. As we can see, (i) not doing the exact computation (i.e., k′=None) leads to large drop in top-1 accuracy. Similarly, using a k′ that is much larger than k is important in obtaining the top-k tokens correctly.

TABLE 4

| HiRE-LR for Softmax (r = 25%) | | k′ = None | k′ = 32 | k′ = 64 | k′ = 128 | k′ = 256 | k′ = 384 | k′ = 512 |
|---|---|---|---|---|---|---|---|---|
| Pre-training | Top1 Accuracy | 51.87% | 56.43% | 56.63% | 56.77% | 56.86% | 56.89% | 56.92% |
| Performance | Top32 Intersection | 19.24 | 19.24 | 24.13 | 26.94 | 28.72 | 29.26 | 29.93 |
| HiRE-Q for Softmax (int4) | | k′ = None | k′ = 2 | k′ = 4 | k′ = 8 | k′ = 32 | k′ = 64 | k′ = 128 |
| Pre-training | Top1 Accuracy | 55.949% | 56.76% | 56.94% | 56.98% | 56.99% | 56.99% | 56.99% |
| Performance | Top32 Intersection | 27.68 | 1.98 | 3.96 | 7.90 | 27.68 | 30.86 | 31.30 |

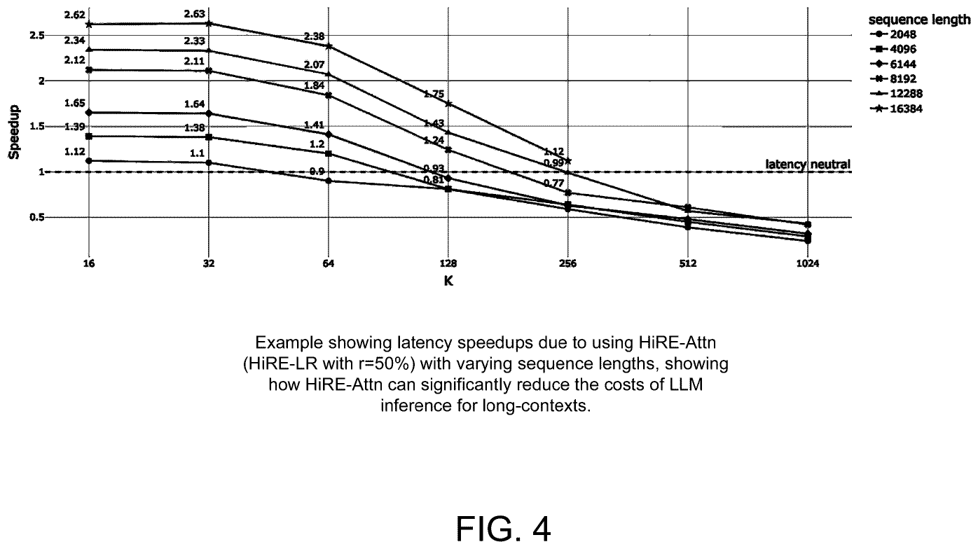

FIG. 4 is a graph that shows latency speedups from using HiRE-Attn (HiRE-LR with r=50%) with varying sequence lengths. The attention layer is a small component of latency for short sequence lengths (few thousand tokens) but quickly becomes dominant with increasing sequence lengths. The plot highlights the ability of HiRE-Attn to significantly reduce the costs of LLM inference for long-contexts.

In short, HiRE speeds up autoregressive inference of LLMs on softmax, feed-forward, and attention layers. The technique can exploit inherent sparsity in each of these layers by (1) computing approximate activations/logits, (2) identifying a small set containing the top-k elements of the exact computation, and (3) performing exact computations only on the identified subset. Our experiments on a 1B parameter model demonstrate that HiRE matches the accuracy of the original model, while obtaining 1.47× speedup on end-to-end latency when applied on softmax and FFN layers, and over 2× speedup on attention layer latency when applied to attention layer with a context length of 16384. Our approach requires minimal additional finetuning pretrained models to work—for the quantization approach, no additional training is required, and for the low rank approach, we use less than 0.1% of the overall training cost of the pretrained model.

HiRE addresses the autoregressive component of LLMs, and does not provide speedups on prefill/prefix processing. While the autoregressive component is currently the key bottleneck during inference, speeding up prefill processing is also equally important for very long context lengths. In some implementations, HIRE can be extended to multi-query attention instead of multi-head attention. In some cases, there may be further benefit in training HiRE models (e.g., approximate matrices) from scratch instead of applying it as a finetuning step. In addition, the required sparse operations in HiRE may be implemented through hardware-aware algorithms.

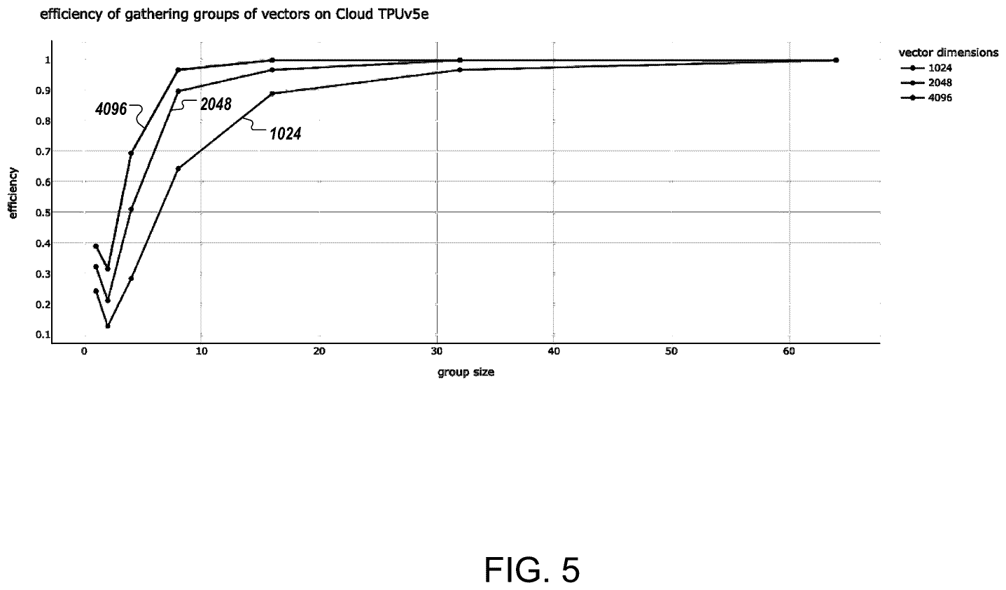

Structured sparsity and hardware support: From the hardware/systems point of view, there have been several techniques developing efficient sparse operations on GPUs and TPUs. Since unstructured sparsity is not supported with efficient execution on GPUs, there have been several that try either different forms of structured sparsity such as 1 in 4 sparsity, group sparsity with large group sizes, or explore the efficiency of sparse transformers on CPUs. In this work, we show that while fully unstructured sparsity is not efficiently supported on TPUs, surprisingly, group structured sparsity with even small group sizes like 8, is efficiently supported on TPUs (see FIG. 5), while not losing in terms of pretraining or downstream quality.

Mixture of experts (MoE): MoE can be thought of as an extreme version of structured sparsity, where the group size is very large, and have been explored both for training as well as inference efficiency. However, MoE models are usually harder to train, since one needs to both learn a gating mechanism, as well as ensure that tokens are roughly equally distributed across experts. In contrast, small group sizes (or experts) are much easier to train, particularly with the Top-k operation.

Complementary approaches for inference efficiency: There have been several complementary approaches for speeding up LLM inference such as model compression, quantization, speculative decoding, early exit and parallel decoding, structured matrices in FFN layers, other systems aspects such as effective partitioning of the model, communication protocols across multiple devices, etc. For attention layers, people have also proposed variants of attention such as Linformer, Performer, state space models, but quadratic self attention is still the dominant paradigm.

Importance of learned projections in HIRE-LR: While HiRE-Q is much easier to implement since it does not require any training, the potential for gains is limited due to the inherent nature of quantization. On the other hand, HIRE-LR has the potential to deliver larger latency improvements, but requires retraining. In this section, we explore whether random projections can be directly used instead of learning them. Table 6 in Appendix C demonstrates that random projections can lead to as much as 10% reduction in downstream evaluation accuracy at similar rank justifying our approach of learned low-rank projections.

FIG. 5 is a graph showing an example of results for efficiency of memory transfer vs group sizes: For a tensor of dimension n×g×d, which we consider as n groups, each with g vectors of dimension d, we plot the efficiency of transferring a random (non-contiguous) subset of groups from HBM to cache as we vary the group size g on the x-axis. Efficiency is defined as the time taken by the sparse operation divided by the time taken by an equivalent dense operation moving the same number of bytes. The numbers are computed for Cloud TPUv5e. As is clear from the figure, even small group sizes such as 8 lead to very high efficiency, motivating the group sparse structure in our feedforward layers.

Table 5 below addresses whether we need to recall more elements than k in HiRE-FFN. Each column contains pretraining metrics for the HiRE-FFN model by using various values of k′ and k (indicated in the table as (k′, k)), in comparison with the dense baseline model M_{base}. Full denotes k′=m where m is the total number of hidden units. Baseline refers to dense model trained without the top-k operation. As we can see from the results, using a larger k′ compared to k is significant for bridging the quality gap between the dense and top-k models.

| | | (128, 128) | (192, 128) | (256, 128) | (Full, 128) | Baseline |
|---|---|---|---|---|---|---|
| Pre-training | Top1 Accuracy | 56.81% | 56.96% | 57.03% | 57.05% | 57.15% |
| Performance | Perplexity | 2.071 | 2.06 | 2.056 | 2.054 | 2.045 |

Location of sparse layers: Recall from the discussion above, the group sparse FFN layer:

$${g \cdot \frac{{k}^{′}}{g}}_{} ( \vec{x} ) := {\sum }_{j ∈ {\tilde{S}}_{g} ( \vec{x} )} {\sum }_{ℓ = 0}^{g} ϕ ( 〈 {\vec{u}}_{g * j + ℓ} , \vec{x} 〉 ) {\vec{v}}_{g * j + ℓ} . \qquad ( 7 )$$

In all the results so far, we have modified only the odd FFN layers to be sparse ((Eqn. 7)), while the remaining were dense ((Eqn. 3)). In Table 7, we present results for different choices of sparse layers, which demonstrate that modifying all the layers to be sparse leads to substantial drop in accuracy, and the location of sparse layers makes an effect on the overall accuracy. It is interesting to identify the optimal selection of sparse layers.

Enhancing sparsity further by exploiting static and dynamic activation overlap: Motivated by the observation that there is substantial overlap in non-zero activations across tokens, we also propose the following approaches to exploit static and dynamic activation overlap.

Static overlap: The first idea is to augment the sparse FFN layer with a dense common path of neurons that are activated for all tokens, so that the number of non-zeros in the sparse part can be reduced further. More concretely, the feedforward layer comprises of two sets of m₁ and m₂ hidden units respectively, where the first set of neurons is used in a dense manner (Eqn. 3), while the second set is used in a group sparse manner (Eqn. 7). We have:

$${CommonPath}_{} ( \vec{x} ) = {\sum }_{j = 1}^{{m}_{1}} ϕ ( 〈 {\vec{u}}_{j}^{d} ; , \vec{x} 〉 ) {\vec{v}}_{j}^{d} + {\sum }_{j ∈ {\tilde{S}}_{g} ( \vec{x} )} {\sum }_{ℓ = 0}^{g} ϕ ( 〈 {\vec{u}}_{g * j + ℓ}^{{g}^{s}} , \vec{x} 〉 ) {\vec{v}}_{g * j + ℓ}^{{g}^{s}} , \qquad ( 8 )$$

where \vec{u}^{d}, \vec{v}^{d} denote the first set of hidden units used in a dense manner, while \vec{u}^{gs}, \vec{v}^{gs} denote the second set of neurons used in a sparse manner.

Dynamic overlap: In order to further improve efficiency while producing a larger number of samples for the same query (e.g., to rank these responses and output the best one), we first compute \tilde{S}_{g}(\vec{x}₁), . . . , \tilde{S}_{g}(\vec{x}ₛ) for the latest token from each of the s samples and use their union U_{u∈[s]}\tilde{S}_{g}(\vec{x}ᵤ) on line 1 of Algorithm 1 and 2.

We now present results demonstrating the utility of a common path, to further enhance activation sparsity as described above, (Eqn. 8). The results, presented in Table 8 show that the common path technique is indeed able to improve dynamic sparsity by 2% while still maintaining accuracy, which leads to about 6% lower latency.

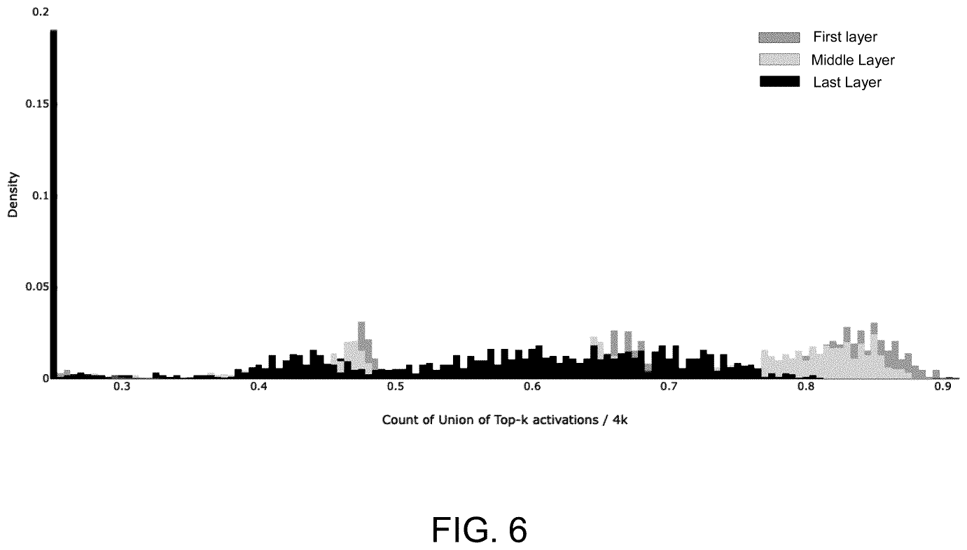

Exploiting activation overlap for larger numbers of samples with adaptive sparsity: It has been shown that generating multiple diverse responses for a single query, and subsequent ranking aids in selecting the most suitable output. We hypothesize that such responses share significant overlap in their non-zero neural activations, offering potential for enhancing effective sparsity in FFN layers. This is supported empirically (FIG. 6), where the union of non-zero activations across multiple responses is consistently smaller than the sum of number of individual response activations.

DA-TOP-k: Multi-device serving with approximate distributed top-k operation: Very large models do not fit on the RAM of a single GPU/TPU, so for serving such models, the parameters of the model are usually distributed on a cluster of multiple devices. In this case, using HIRE (Algorithm 1) as is leads to large costs in communication. To mitigate the communication costs, we modify HIRE to use distributed, approximate top-k computation. The pseudocode for the resulting algorithm is given in Algorithm 2. As we can see from Table 9, DA-TOP-k (Algorithm 2) improves the latency by 2.27×, compared to the vanilla implementation of HIRE (Algorithm 1), with comparable quality on average across downstream tasks.

Table 6 below shows the importance of learned low rank matrix. This table presents the pretraining metrics by using random vs learned low rank projection. As we can see, learning the projection matrix is crucial for maintaining quality.

TABLE 6

| | | | Trained, k = 384 | Random, k = 384 | | | |
|---|---|---|---|---|---|---|---|
| | | Baseline | r = 25% | r = 25% | r = 33% | r = 50% | r = 66% |
| Pre-training | Top1 Accuracy | 57.40% | 57.29% | 46.78% | 49.26% | 54.02% | 55.81% |
| Performance | Top32 Intersection | 32.0 | 29.26 | 15.53 | 18.42 | 24.21 | 26.89 |

Table 7 below shows ablation on architectures. We train models with multiple sparse FFN layer configurations and evaluate with approximate k′=256 and k=128 for all models. L, D and S denote the number of layers in the model, dense layer ((Eqn. 3)) and sparse layer ((Eqn. 7)) respectively. (D, S) means alternating dense and sparse layers, while Last L/2 refers to the final L/2 layers being sparse and the remaining being dense.

TABLE 7

| | | Baseline | (D S) × L/2 | Last L/2 | (D S S) × L/3 | Last 2L/3 | L layers |
|---|---|---|---|---|---|---|---|
| Pre-training | Top1 Accuracy | 57.15% | 57.03% | 57.03% | 56.84% | 56.83% | 56.24% |
| Performance | Perplexity | 2.045 | 2.056 | 2.058 | 2.069 | 2.071 | 2.108 |
| Downstream | Machine Translation | 47.92 | 46.95 | 46.35 | 46.17 | 45.83 | 44.35 |
| Performance | SuperGLUE Benchmark | 62.07 | 62.49 | 60.43 | 59.37 | 60.74 | 59.3 |
| | Question Answering | 29.65 | 30.88 | 29.86 | 28.88 | 29.09 | 27.51 |
| | Discriminative Tasks | 51.69 | 51.14 | 50.99 | 50.37 | 50.8 | 49.65 |
| | Speedup | 1.0x | 1.16x | 1.18x | 1.17x | 1.18x | 1.44x |

Table 8 below shows Commonpath Experimental Results: Static sparsity denotes the percentage of feedforward neurons used by all tokens i.e. commonpath while Adaptive Sparsity denotes the percentage of neurons activated by feedforward neurons not in commonpath.

TABLE 8

| | | Baseline | Sparse | CommonPath |
|---|---|---|---|---|
| Sparsity | Static Sparsity | 100% | 0% | 16.66% |
| | Adaptive Sparsity | NA | 5.55% | 3.33% |
| Pre-training | Top1 Accuracy | 57.15% | 57.03% | 57.03% |
| Performance | Perplexity | 2.045 | 2.056 | 2.055 |
| Downstream | MT | 47.92 | 46.95 | 46.93 |
| Performance | SuperGLUE | 62.07 | 62.49 | 61.66 |
| | Q & A | 29.65 | 30.88 | 29.94 |
| | Disc. Tasks | 51.69 | 51.14 | 51.14 |
| | Speedup | 1.0× | 1.16× | 1.22× |

FIG. 6 is a graph that shows dynamic overlap of top-k activations across related responses while generating 4 parallel samples for the same query. On x-axis is the size of union of top-k activations across 4 generations divided by 4k, for k=(0.05)*m₁. As we can see, there is substantial fraction of mass away from 1, suggesting that the top-k activations of related responses have high overlap, which can yield further latency improvements with HIRE.

Table 9 below shows an example of results for DA-TOP-k (Algorithm 2): Quality and latency evaluations for the HiRE-FFN model deployed on a 2×2 slice of Google Cloud TPUv5e. Clearly performing distributed, approximate top-k computation is very valuable to obtain speedups during deployment on multiple machines, while not losing any quality on average.

TABLE 9

| | | | [symbol] _{ffn} + |
|---|---|---|---|
| | | [symbol] _{ffn} | HiRE-Q + |
| | | (HiRE-Q) | (DA-TOP-k) |
| Pre-training | Top1 Accuracy | 57.03% | 56.82% |
| Performance | Perplexity | 2.056 | 2.064 |
| Downstream | Machine Translation | 46.95 | 47.03 |
| Performance | SuperGLUE Benchmark | 62.49 | 61.37 |
| | Question Answering | 30.88 | 30.11 |
| | Discriminative Tasks | 51.14 | 50.33 |

| | | |
|---|---|---|
| Speedup | 1.0× | 2.27× |

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for performing efficient neural network processing using selective processing of neural network parameters, the method being performed by one or more computers, wherein the method comprises:
storing, by the one or more computers, parameter values for a trained neural network comprising multiple layers, including storing for at least one layer of the multiple layers (i) a matrix of parameter values for the at least one layer and (ii) an approximate matrix of values corresponding to the at least one layer;
processing, by the one or more computers, input using the trained neural network, including:
determining an input for the at least one layer;
computing approximate outputs corresponding to elements in a set using the approximate matrix corresponding to the at least one layer and the input for the at least one layer;
computing intermediate outputs for only a proper subset of the elements in the set using the matrix of parameter values for the at least one layer, wherein the proper subset is determined based on the approximate outputs; and
generating the output of the at least one layer based on the intermediate outputs; and
providing, by the one or more computers, an output of the trained neural network that is generated based on the output of the at least one layer.

2. The method claim 1, wherein the at least one layer comprises a softmax layer that has a softmax matrix and a corresponding approximate softmax matrix;
wherein computing the approximate outputs comprises computing approximate softmax outputs for each element in a set using the approximate softmax matrix;
wherein computing the intermediate outputs comprises computing softmax outputs for only the proper subset of the elements in the set using the softmax matrix, wherein the proper subset is determined based on the approximate softmax outputs; and
wherein generating the output of the at least one layer comprises generating the output of the softmax layer based on the softmax outputs.

3. The method claim 1, wherein the at least one layer comprises a feed-forward layer that has a feed-forward matrix and a corresponding approximate feed-forward matrix;
wherein computing the approximate outputs comprises computing approximate feed-forward outputs for each element in a set using the approximate feed-forward matrix;
wherein computing the intermediate outputs comprises computing feed-forward outputs for only the proper subset of the elements in the set using the feed-forward matrix, wherein the proper subset is determined based on the approximate feed-forward outputs; and
wherein generating the output of the at least one layer comprises generating the output of the feed-forward layer based on the feed-forward outputs.

4. The method of claim 1, wherein the at least one layer comprises an attention layer that has one or more attention matrices and corresponding one or more approximate attention matrices;
wherein computing the approximate outputs comprises computing approximate attention outputs for the sequence of vectors using the one or more approximate attention matrices;
wherein computing the intermediate outputs comprises computing attention outputs for only a proper subset of the vectors in the sequence of vectors using the one or more attention matrices, wherein the proper subset is determined based on the approximate attention outputs; and
wherein generating the output of the at least one layer comprises generating the output of the attention layer based on the attention outputs.

5. The method of claim 4, wherein computing the approximate attention outputs comprises computing approximate attention logits using the one or more approximate attention matrices; and
wherein computing the attention outputs comprises using the attention matrices to compute attention logits restricted to the highest-ranking set of the approximate attention outputs.

6. The method of claim 4, wherein processing the input using the trained neural network is performed by one or more accelerators having on-chip memory and associated off-chip memory; and
wherein the method comprises, after computing the approximate attention outputs:
based on the approximate attention outputs, selectively loading vectors from a sequence of vectors from the off-chip memory into the on-chip memory for processing with the one or more attention matrices.

7. The method of claim 4, wherein the trained neural network is a large language model; and
wherein generating the output of the at least one layer comprises generating output of the attention layer over a sequence of input token representations corresponding to a sequence of input tokens for the large language model.

8. The method of claim 7, wherein the sequence of input token representations is a sequence of embeddings generated by an encoder of the trained neural network.

9. The method of claim 1, wherein processing the input using the trained neural network is performed by one or more accelerators having on-chip memory and associated off-chip memory; and
wherein the method comprises, after computing the approximate outputs:
based on the approximate outputs, selectively loading a subset of weight values for the at least one layer from the off-chip memory into the on-chip memory for processing.

10. The method of claim 1, wherein the approximate matrix for the at least one layer has been trained, separately from the training of the corresponding matrix for the at least one layer, with other layers of the trained neural network.

11. The method of claim 1, wherein the approximate matrix for the at least one layer includes values for fewer parameters than the corresponding matrix for the at least one layer.

12. The method of claim 1, wherein the approximate matrix for the at least one layer includes values stored using fewer bits per parameter than the corresponding matrix for the at least one layer.

13. The method of claim 1, wherein the approximate matrix for the at least one layer is a low-rank approximation for the corresponding matrix for the at least one layer.

14. The method of claim 1, wherein the approximate matrix for the at least one layer derived from the corresponding matrix through low rank decomposition of the corresponding matrix for the at least one layer.

15. The method of claim 1, wherein the approximate matrix for the at least one layer comprises quantized versions of parameter values of the corresponding matrix for the at least one layer.

16. The method of claim 1, wherein the approximate matrix is factorized to include multiple matrices, wherein a total amount of parameter values in the multiple matrices is lower than an amount of parameter values in the corresponding matrix of the at least one layer.

17. The method of claim 1, wherein the approximate matrix is configured to indicate, for different sets of input, different subsets of the elements that each include a highest-relevance subset of the elements.

18. The method of claim 1, wherein the at least one layer has a set of hidden units, and wherein the set of hidden units is divided into groups that each comprise multiple hidden units; and
wherein generating the output of the at least one layer comprises:
determining an approximate group activation score for each of the groups, wherein each approximate group activation score is based on the approximate outputs for the hidden units in the group;
computing intermediate outputs for only a proper subset of the groups of hidden units of the at least one layer using the matrix, wherein the proper subset of the groups is determined based on the approximate group activation scores; and
generating the output of the at least one layer based on the intermediate outputs.

19. A system comprising:
one or more computers; and
one or more computer-readable media storing instructions that are operable, when executed by the one or more computers, to cause the system to perform operations comprising:
storing, by the one or more computers, parameter values for a trained neural network comprising multiple layers, including storing for at least one layer of the multiple layers (i) a matrix of parameter values for the at least one layer and (ii) an approximate matrix of values corresponding to the at least one layer;
processing, by the one or more computers, input using the trained neural network, including:
determining an input for the at least one layer;
computing approximate outputs corresponding to elements in a set using the approximate matrix corresponding to the at least one layer and the input for the at least one layer;
computing intermediate outputs for only a proper subset of the elements in the set using the matrix of parameter values for the at least one layer, wherein the proper subset is determined based on the approximate outputs; and
generating the output of the at least one layer based on the intermediate outputs;
providing, by the one or more computers, an output of the trained neural network that is generated based on the output of the at least one layer.

20. One or more non-transitory computer-readable media storing instructions that are operable, when executed by one or more computers, to cause the one or more computers to perform operations comprising:
storing, by the one or more computers, parameter values for a trained neural network comprising multiple layers, including storing for at least one layer of the multiple layers (i) a matrix of parameter values for the at least one layer and (ii) an approximate matrix of values corresponding to the at least one layer;
processing, by the one or more computers, input using the trained neural network, including:
determining an input for the at least one layer;
computing approximate outputs corresponding to elements in a set using the approximate matrix corresponding to the at least one layer and the input for the at least one layer;
computing intermediate outputs for only a proper subset of the elements in the set using the matrix of parameter values for the at least one layer, wherein the proper subset is determined based on the approximate outputs; and
generating the output of the at least one layer based on the intermediate outputs;
providing, by the one or more computers, an output of the trained neural network that is generated based on the output of the at least one layer.
